(19) United States
(12) Patent Application Publication
(10) Pub. No.: US 2020/0034745 A1
(43) Pub. Date: Jan. 30, 2020

(54) TIME SERIES ANALYSIS AND FORECASTING USING A DISTRIBUTED TOURNAMENT SELECTION PROCESS

(71) Applicant: Nutanix, Inc., San Jose, CA (US)

(72) Inventors: Abhinay NAGPAL, San Jose, CA (US); Himanshu SHUKLA, San Jose, CA (US); Cong LIU, Foster City (CA); Jianjun WEN, San Jose, CA (US)

(73) Assignee: Nutanix, Inc., San Jose, CA (US)

(21) Appl. No.: 15/251,244

(22) Filed: Aug. 30, 2016

Related U.S. Application Data
(60) Provisional application No. 62/243,655, filed on Oct. 19, 2015.

(51) Int. Cl. G06N 99/00; G06N 5/02

(52) U.S. Cl. CPC G06N 99/005; G06N 5/022

(57) ABSTRACT

A system for implementing seasonal time series analysis and forecasting using a distributed tournament selection process. Time series analysis is initiated by a prediction or runway event trigger. Prediction events include a determination of the availability of one or more resources at a given point in time or over a given time period. A runway event may include a determination of when a resource is below a minimum threshold level of availability. Training of the prediction models is based data taken from different time periods, accounting for any combination of time periods and/or for differing sampling frequencies or ranges. Processes for prosecuting a tournament to identify winning models are parallelized to achieve low latency tournament results. Ranking of each model and/or some combination of models is based on how precisely and/or conclusively the models match a determined set of training data.

### RELATED APPLICATIONS

The present application claims the benefit of priority to U.S. Provisional Patent Application No. 62/243,655 filed Oct. 19, 2015, entitled “SEASONAL TIME SERIES ANALYSIS AND FORECASTING USING A DISTRIBUTED TOURNAMENT SELECTION PROCESS”, which is hereby incorporated by reference in its entirety.

### FIELD

This disclosure relates to storage system performance modeling and reporting, and more particularly to techniques for time series analysis and forecasting using a distributed tournament selection process.

### BACKGROUND

The cost of purchasing and maintaining servers and technological equipment can represent a significant drain on the resources of a company and substantially affect their bottom line. Furthermore, for companies that are in the business of providing computing to others as a service, the difference between a well-managed computing infrastructure and a poorly-managed computing infrastructure can be the difference between a profitable enterprise and a failed enterprise.

Given the size and complexity of modern systems, it is difficult for an individual to determine the best actions to take to maintain a system at a specified target level based on only human experiences. One possible approach to ameliorate such difficulties is to use one or more techniques for time series analysis to assist users in provisioning their systems.

Time series analysis refers to the process of collecting and analyzing time series data so as to extract meaningful statistics and characteristics about the collected data. Computer models can be used within a computing framework for mathematically representing predicted future values based on previously measured values. Examples of such models include autoregressive models, integrated models, moving average models, etc. and/or various combinations of the foregoing with each model type having particular respective indications and contraindications. For instance, popular models include the autoregressive integrated moving average (ARIMA) models, exponential smooth (ETS) models, seasonal trend decomposition using loess (STL) models, neural networks, random walk models, seasonal naïve, mean and/or linear regression models, among others.

Any individual application of such models may select a specific analysis model for a particular given task. Selection of a model to use can be a result of a substantial amount of analysis of the data so as to determine the best model for the particular given task. For instance, to choose the correct ARIMA model, a calculation module might check if the time series is stationary using tests for the stationary property, and if so, use the ARIMA model, otherwise the time series may have to be differenced. Legacy tools rely on a single model type for any given function or data type regardless of the underlying time series data to be analyzed. Such a legacy “one-size-fits-all” approach fails to produce acceptable results when the underlying time series data varies over time. The problems attendant to legacy techniques are further exacerbated by inaccuracies in results and/or the limited scope of pertinence of results that arise due to the sheer magnitude of data collected, of the amount of data to be analyzed, and by the dynamic nature of the data. Yet, there is an ever-increasing desire for accurate and pertinent analysis and forecasting.

What is needed is a technique or techniques to improve over legacy and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

What is needed is an improved method for time series analysis that allows for greater flexibility and more accurate forecasting.

### SUMMARY

The present disclosure provides a detailed description of techniques used in systems, methods, and in computer program products for seasonal time series analysis and forecasting using a distributed tournament selection process, which techniques advance the relevant technologies to address technological issues with legacy approaches. Certain embodiments are directed to technological solutions to implement a high-performance distributed tournament selection capability such that many models can be evaluated and selected in real time, which embodiments advance the relevant technical fields as well as advancing peripheral technical fields.

The disclosed embodiments modify and improve over legacy approaches. In particular, the herein-disclosed techniques provide technical solutions that address the technical problems attendant to achieving accurate forecasting of a storage system's performance when multiple forecasting models need to be employed depending on the underlying time series data to be analyzed and used in real-time forecasting. Such technical solutions serve to distribute the demand for computer memory, distribute the demand for computer processing power, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance computing as well as advances in various technical fields related to distributed storage.

Further details of aspects, objectives, and advantages of the technological embodiments are described herein and in the following descriptions, drawings, and claims.

### BRIEF DESCRIPTION OF THE DRAWINGS

The drawings described below are for illustration purposes only. The drawings are not intended to limit the scope of the present disclosure.

FIG. 1A1 and FIG. 1A2 exemplifies intersystem interactions between systems that implement forecasting using a distributed tournament selection process.

FIG. 1B illustrates a partitioning approach pertaining to systems that implement seasonal time series analysis and forecasting using a distributed tournament selection process, according to an embodiment.

FIG. 1C presents an example user interface for interacting with systems that perform seasonal time series analysis and forecasting using a distributed tournament selection process, according to some embodiments.

FIG. 1D depicts a system for performing time series analysis and forecasting using a distributed tournament selection process, according to an embodiment.

FIG. 1E depicts a system for performing time series analysis and forecasting using a distributed tournament selection process, according to an embodiment.

FIG. 2 presents a ladder diagram of a protocol for performing time series analysis and forecasting using a distributed tournament selection process, according to some embodiments.

FIG. 3 presents an operation flowchart that describes a technique for performing seasonal time series analysis and forecasting using a distributed tournament selection process, according to an embodiment.

FIG. 4 presents a flowchart of a triggering technique as used in systems that perform seasonal time series analysis and forecasting using a distributed tournament selection process, according to some embodiments.

FIG. 5 presents a flowchart of a prediction model training technique as used in systems that perform seasonal time series analysis and forecasting using a distributed tournament selection process, according to some embodiments.

FIG. 6 presents a multi-model evaluation technique as used in systems that perform seasonal time series analysis and forecasting using a distributed tournament selection process, according to an embodiment.

FIG. 7 presents a multi-solution evaluation technique as used in systems that perform seasonal time series analysis and forecasting using a distributed tournament selection process, according to an embodiment.

FIG. 8A illustrates a local model selection approach as used in systems that perform seasonal time series analysis and forecasting using a distributed tournament selection process, according to an embodiment.

FIG. 8B illustrates a global model selection approach as used in systems that perform seasonal time series analysis and forecasting using a distributed tournament selection process, according to an embodiment.

FIG. 9 depicts a clustered virtualization environment as used in systems that perform seasonal time series analysis and forecasting using a distributed tournament selection process, according to an embodiment.

FIG. 10 depicts centralized workload partitioning in an environment comprising systems that perform seasonal time series analysis and forecasting using a distributed tournament selection process, according to an embodiment.

FIG. 11 depicts distributed workload partitioning in an environment comprising systems that perform seasonal time series analysis and forecasting using a distributed tournament selection process, according to an embodiment.

FIG. 12 depicts system components as arrangements of computing modules that are interconnected so as to implement certain of the herein-disclosed embodiments.

FIG. 13A and FIG. 13B depict architectures comprising collections of interconnected components suitable for implementing embodiments of the present disclosure and/or for use in the herein-described environments.

### DETAILED DESCRIPTION

Some embodiments of the present disclosure address the problem of achieving accurate forecasting of a storage system's performance. Multiple forecasting models need to be employed depending on the underlying time series data to be analyzed and used in forecasting. Some embodiments are directed to approaches for a high-performance distributed tournament selection capability such that many models can be evaluated and selected in real time. The accompanying figures and discussions herein present example environments, systems, methods, and computer program products for seasonal time series analysis and forecasting using a distributed tournament selection process.

### Overview

The present disclosure provides an architecture for implementing seasonal time series analysis and forecasting using a distributed tournament selection process. To illustrate the embodiments of the disclosure, various embodiments are described in the context of a virtualization environment. It is noted, however, that the disclosure is applicable to other types of systems as well, and is therefore not limited to virtualization environments unless explicitly claimed as such. Indeed, the disclosure is applicable to any distributed system capable of implementing seasonal time series analysis and forecasting using a distributed tournament selection process.

A “virtual machine” or a “VM” refers to a specific software-based implementation of a machine in a virtualization environment in which the hardware resources of a real computer (e.g., CPU, memory, etc.) are virtualized or transformed into the underlying support for the fully functional virtual machine that can run its own operating system and applications on the underlying physical resources just like a real computer. Virtualization works by inserting a thin layer of software directly onto the computer hardware or onto a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including the CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows multiple virtual machines to run on a single physical machine, with each virtual machine sharing the resources of that one physical computer across multiple environments. Different virtual machines can run different operating systems and multiple applications on the same physical computer. One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not used to perform useful work. This is wasteful and inefficient if there are users on other physical machines which are currently waiting for computing resources. To address this problem, virtualization allows multiple VMs to share the underlying physical resources, including sharable storage assets in a storage pool so that during periods of inactivity by one VM, other VMs can take advantage of the resource availability to process workloads. This can produce great efficiencies for the use of physical devices, and can result in reduced redundancies and better resource cost management.

Virtualization systems have now become a relatively common type of technology used in many company and organizational data centers, with ever increasing and advanced capabilities being provided for users of the system. However, the ability of users to manage these virtualization systems have thus far not kept up with the rapid advances made to the underlying systems themselves.

As noted above, one area where this issue is particularly noticeable and problematic is with respect to the desire to more efficiently provision and manage these systems. Therefore, what is described is a process of analyzing time series data so as to extract meaningful statistics and characteristic about data in a distributed tournament model selection process.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment. An aspect or an advantage described in conjunction with a particular embodiment is not necessarily limited to that embodiment and can be practiced in any other embodiments even if not so illustrated. Also, references throughout this specification to “some embodiments” or “other embodiments” refers to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments.

### Definitions

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Example Embodiments

Time series analysis can be initiated by a prediction or runway event triggered by a user or system. Prediction events may include a determination of the availability of one or more resources at any given point in time or over a given time period. A runway event may include a determination of when a resource will no longer be available or when the resource may be below a minimum threshold level of availability. Such events generally correspond to planning and management activities for a given system. For instance, a user or automated system may initiate operations to analyze the resources of a given system or systems to provide a minimum level of resources for an expected workload. This analysis is useful for general capacity management and for adjusting for seasonal workload variations and quality of service.

In some embodiments, the process comprising handling a triggering event is used to determine an event type, training a set of prediction models for time series analysis as a result of the triggering event, generating predictions and determining available runways using a prediction model or models selected from the trained prediction models, and generating recommendations using the generated predictions and determined runways.

The occurrence of the predication or runway event will result in the training of prediction models. Prediction models are trained with a first set of time series data. Furthermore, training of the prediction models may use data from different time periods, accounting for any combination of short, medium, or long time periods and for differing sampling frequencies or ranges. Training may be executed on a distributed system or clustered virtualization system, which provides a distributed but logically unified storage pool with a plurality of processing units that are similarly distributed.

In some embodiments, a distributed set of processing nodes and/or a cluster may be used in a distributed fashion to perform a tournament selection process between the different models across one or more data sets. The tournament selection process comprises training multiple models using a plurality of sets of first time series data, and evaluating those models using a map reduce operation and a plurality of sets of a second time series data that corresponds to the first time series data. As a result, the tournament process serves to select a model or set of models that best fit the time series data, which selected models can then be used for aggregation or reconciliation with other models to create a single unified model for the plurality of sets of time series data.

Predictions are generated and used for determining runways for one or more resources. The prediction process often comprises performing multiple iterations for each of the models such that the values at each given time point/period may be determined. The process may occur over a given prediction range such as a day, week, month, year, or other time period, or the process may continue until some condition is met such that the iterations should be halted.

The present disclosure further teaches that the process of generating predictions and determining runways can be distributed across multiple nodes such as by executing each individual selected model or combination of models on different nodes to perform parallel evaluation of multiple models for multiple parameters.

The process of generating predictions and determining runways may include rules that identify and filter events that may cause a model or models to become less accurate. Possible corrections are emitted. For instance, a model may be modified to account for disabling or enabling encryption or compression processes. In some cases, a system event might cause a remote backup to be initiated thereby decreasing available processing and network resources, and/or in some cases a system event such as the expiration of a given time period for a set of data might causes migration of the data from a first tier to a slower second tier.

Recommendations are emitted based on the predictions and determined runways. Such recommendations may include recommended configuration/settings changes, installation changes, and/or may include upgrading certain hardware or components.

Further details of aspects, objects, and advantages of the disclosure are described below in the detailed description, drawings, and claims. Both the foregoing general description and the following detailed description are exemplary and explanatory, and are not intended to be limiting as to the scope of the invention.

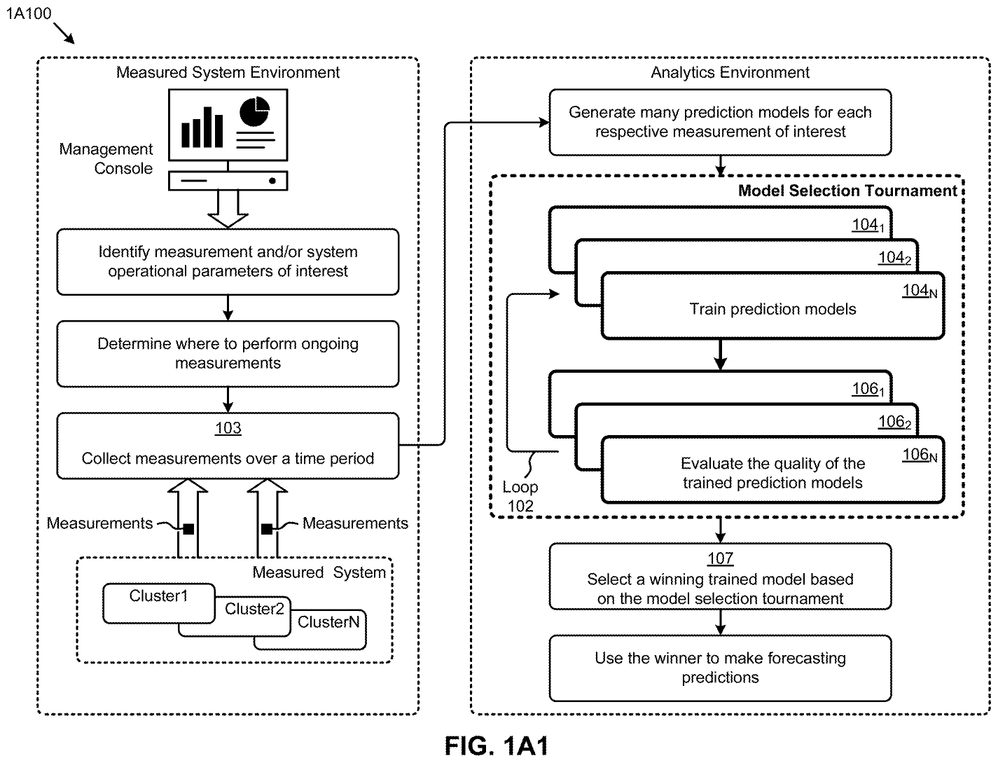

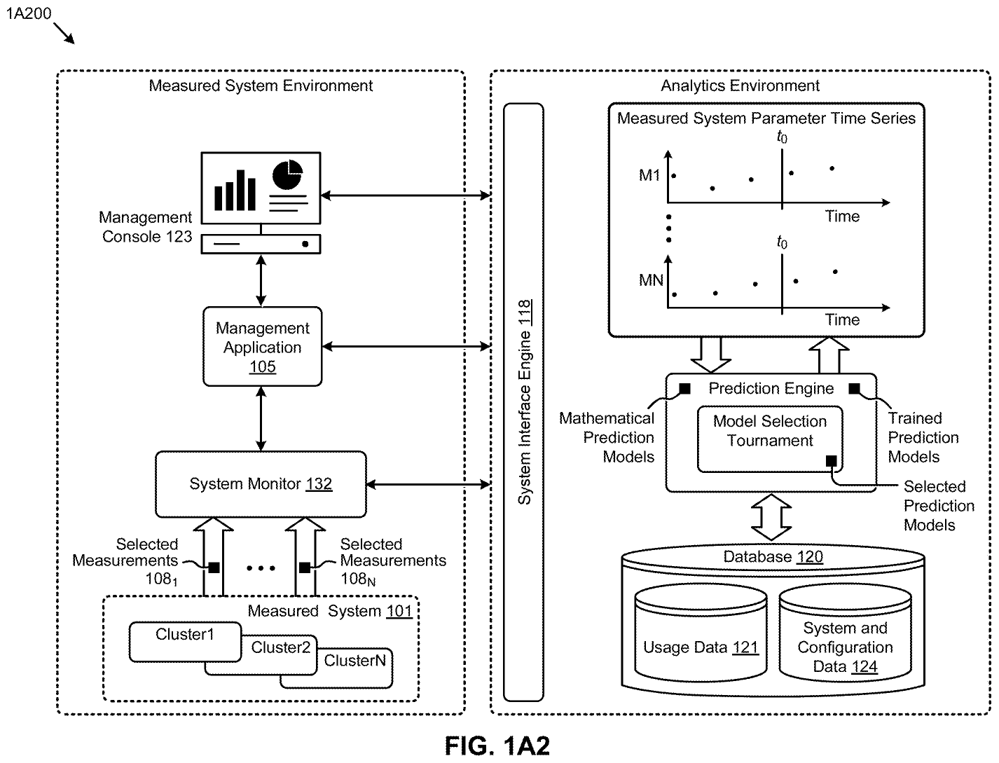

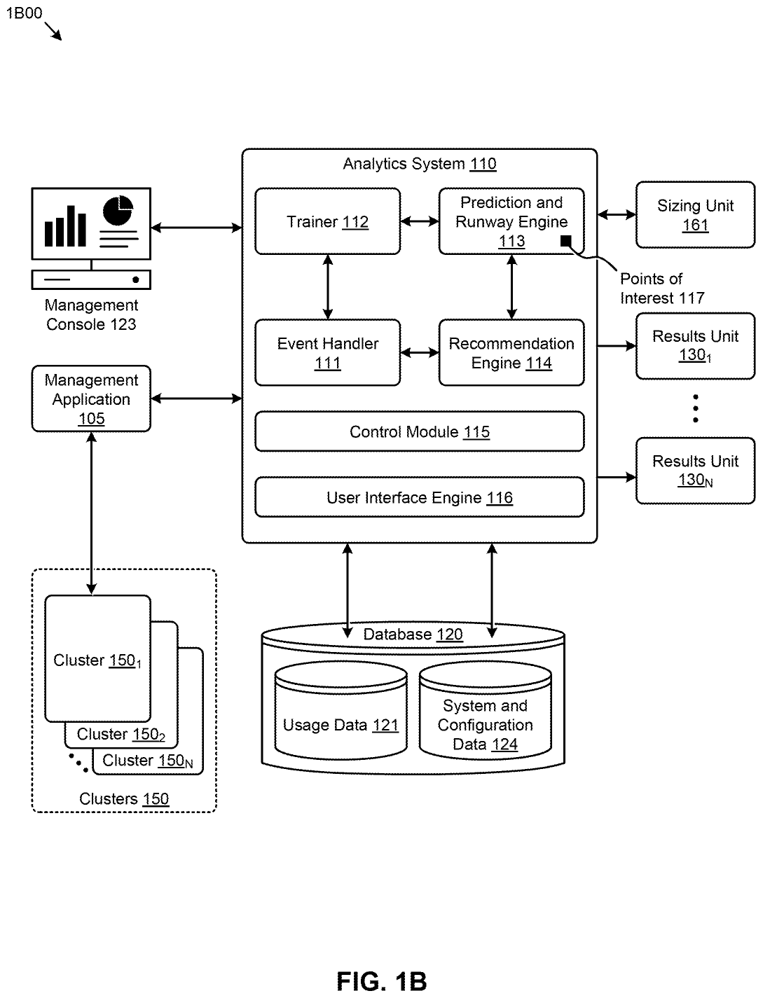

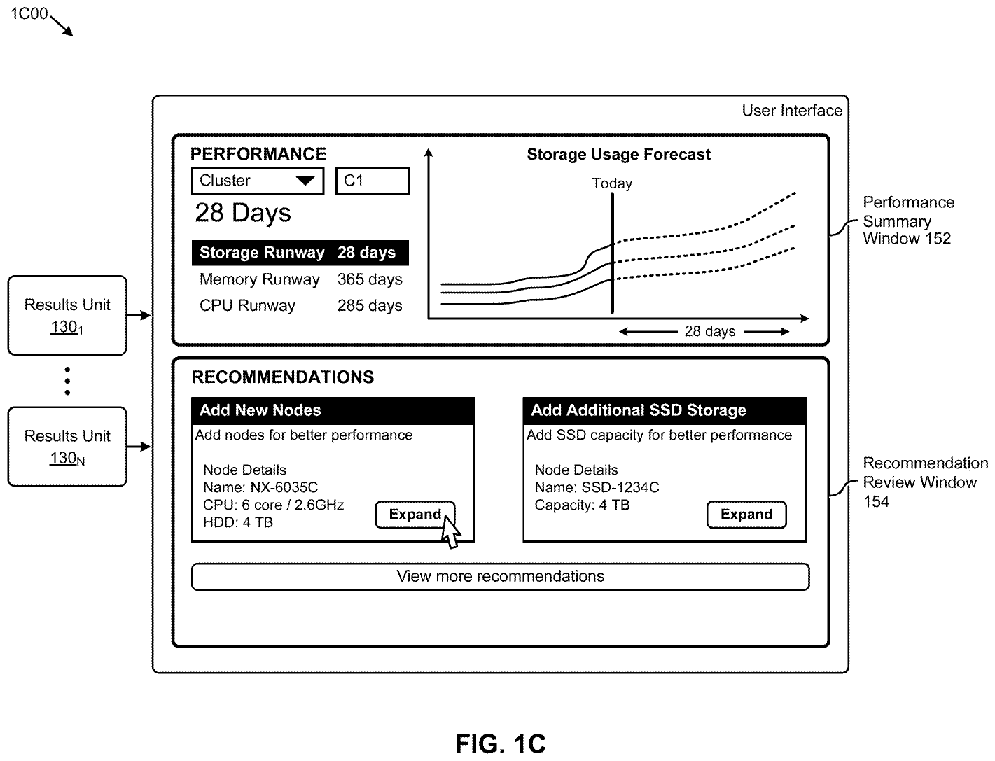

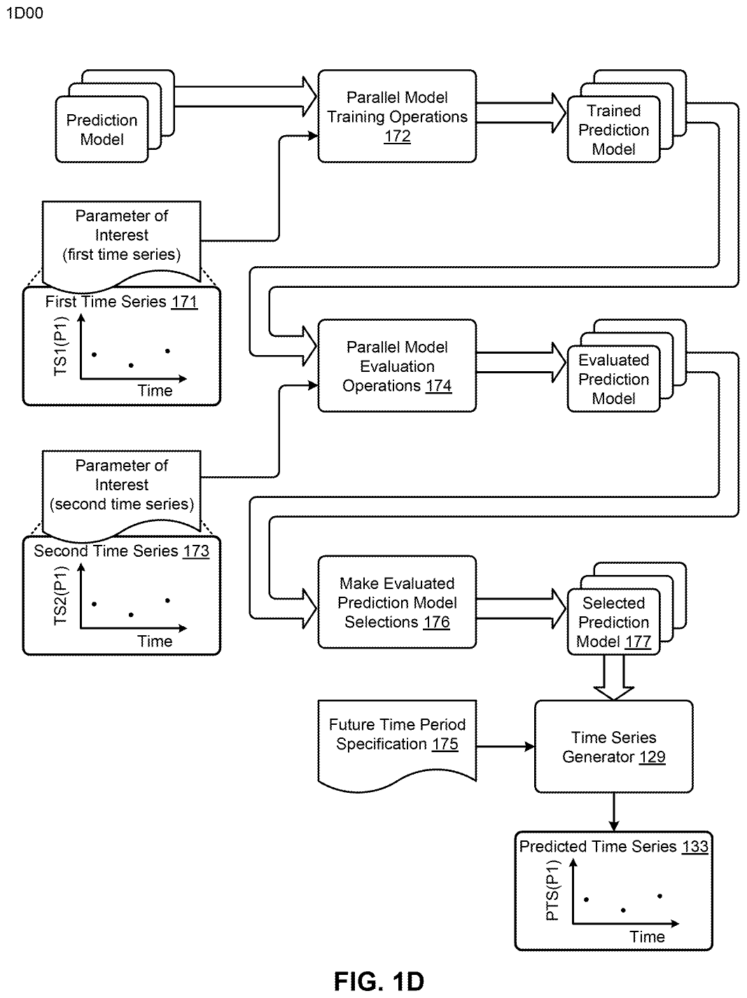

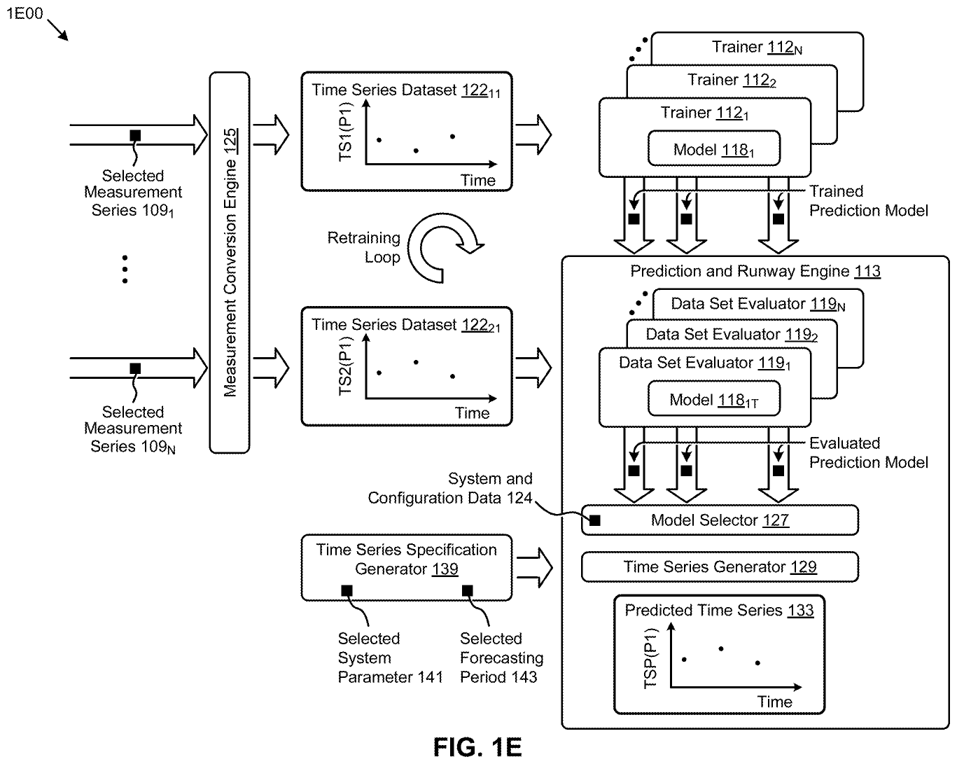

FIG. 1A1 exemplifies a flow of intersystem interactions 1A100 between systems that implement forecasting using a distributed tournament selection process. The embodiment shown in FIG. 1A1 depicts a measured system environment (left side) that includes a management console (top left) for identifying system parameters of interest and a system of interest (bottom left) such that system measurements pertaining to the parameters of interest (e.g., CPU usage, IO latency, etc.) can be collected over time. An analytics environment is also shown (right side). Measurements collected within the measured system environment (e.g., at step 103) can be forwarded to the analytics environment. The analytics environment may include a database of predictive models, often many of which pertain to the parameters of interest. The foregoing models that pertain to the parameters of interest can be subjected to training and evaluation operations in a model selection tournament. In particular, a first set of operations serve to train the models using collected measurements that were taken at the measured system over a historical time period. The trained models can then be evaluated to quantify a degree of quality (e.g., a precision metric, a recall metric, etc.). The training operations in the model selection tournament can be performed in parallel (e.g., many models can be trained in parallel). Further, the evaluation operations in the model selection tournament can be performed in parallel (e.g., many models can be evaluated in parallel).

More specifically, many models can be trained in parallel, such as is depicted by the instances of training operations 104₁, training operations 104₂, . . . , training operations 104_{N}), where each instance of a training operation comprises a particular model and a particular set of measurements over a particular time period. Furthermore after training, many trained models can be evaluated for quality in parallel, such as is depicted by the instances of training evaluation operations 106₁, evaluation operations 106₂, . . . , evaluation operations 106_{N}), where each instance of an evaluation operation comprises a particular trained model and a particular set of measurements over a particular time period. The model training might use a first set of measurements pertaining to the parameter of interest, and the model evaluation might use a second set of measurements pertaining to the parameter of interest where the first set is a proper subset of the second set.

When the tournament has completed the training of the models and evaluations of the trained models, a winner of the tournament is selected (at step 107). The winning model can be used to make forecasting predictions.

Implementation of the techniques of FIG. 1A1 provide technical solutions that address the technical problems attendant to achieving accurate forecasting of a system's performance. More particularly, using a model selection tournament, different forecasting models can be employed depending on a particular model's evaluated quality with respect to an underlying time series of data of interest. For example, a first type of model might perform with good predictive qualities if the underlying data is smooth, whereas another model or type of model might perform poorly when the underlying data is smooth. Yet, a second type of model might perform with good predictive qualities if the underlying data is random, whereas a third type of model might perform poorly when the underlying data is random. Both the model selected and the selected data affect the predictive qualities of such a selected model; thus, a tournament that includes multiple models that are trained using a set of actual historical data and then evaluated for predictive qualities addresses this conundrum.

As previously indicated, both the model selected and the selection of respective training data can affect the predictive qualities of a selected model. As such, it can happen that loop 102 is taken to select different models, and/or to make adjustments to the selection of training and/or evaluation data. In some cases, the results of evaluation of the quality of the trained prediction models can be surprising or unexpected such that loop 102 is taken so as to vary the selection of training data (e.g., to take in more or less data for training, and/or to take in more or less data for evaluation).

The heretofore discussed flow can be partitioned and implemented using any known technologies. One possible partitioning of systems and constituent components is presented in the following FIG. 1A2.

FIG. 1A2 exemplifies intersystem interactions 1A200 between systems that implement forecasting using a distributed tournament selection process. As an option, one or more variations of intersystem interactions 1A200 or any aspect thereof may be implemented in the context of the architecture and functionality of the embodiments described herein. The intersystem interactions between components of the measured system environment and component of the analytics environment can be carried out using any known technique.

The embodiment shown in FIG. 1A2 depicts a measured system 101 (e.g., comprising one or more clusters) that includes instrumentation such that a system monitor 132 can receive and/or analyze and/or forward selected system measurements (e.g., selected measurements 108₁, . . . , selected measurements 108_{N}, etc.). Deployment of instrumentation and/or collection of such measurements can be managed by a management application 105, which in turn can be controlled using a user interface such as a user console (e.g., management console 123).

Measurements collected within the measured system environment can be forwarded to the analytics environment. As shown, a series of measurements can be collected into a time-oriented series. Measurements can pertain to any of a variety of measured system parameters and/or functions of one or more measured system parameters (e.g., M1, Mn, etc.). The analytics environment may include a system interface engine 118 which can receive, analyze and forward any forms of measurements. In particular, a set of measurements can be organized into a measured system parameter time series. Such a time series can be stored so as to cover a historical time period.

Further, such a time series can be constructed so as to forecast a future time period. Strictly as one example, at time T=t₀, a historical time series (e.g., collected prior to time T=t₀) over a particular parameter (e.g., parameter M1, parameter Mn) can be provided to a prediction engine, which in turn can produce a forecast of future values of the particular parameter(s) through a forecasting period. Such a prediction engine can store data that represents the usage of the resources of the system or systems to be evaluated (e.g., see usage data 121). Certain partitioning of such a prediction engine can include a plurality of prediction models that implement any known-in-the-art prediction techniques. Such prediction models can be trained using selected measurements and/or usage data. In some cases, a prediction engine relies on configuration data 124 to determine the nature of predictions such as what system parameters are to be forecasted, how much historical data is to be used for model training, how much and over what period should newly incoming system measurements be used for forecasting, what limits of periodicity is of interest for seasonality analysis, etc.

The modeling and prediction capabilities as shown and described as pertaining to FIG. 1A2 can be augmented so as to implement a tournament for selecting particular models for particular data sets. Further, the winning models (e.g., models that emerge from the tournaments) can be used to produce results in the form of forecasts of “runway(s)” for certain system parameters (e.g., storage capacity, etc.). Still further, the winning models can be used to produce results in the form of recommendations (e.g., system tuning and/or sizing recommendations that are presented in a user interface, etc.).

FIG. 1B illustrates a partitioning approach 1B00 pertaining to systems that implement seasonal time series analysis and forecasting using a distributed tournament selection process. As an option, one or more variations of partitioning approach 1B00 or any aspect thereof may be implemented in the context of the architecture and functionality of the embodiments described herein. The partitioning approach 1B00 or any aspect thereof may be implemented in any environment.

The partitioning approach 1B00 of FIG. 1B is merely one example. As shown, the analytics system 110 includes an event handler 111, trainer 112, prediction and runway engine 113, and recommendation engine 114, each handling some part of the process. The event handler receives one or more inputs corresponding to one or more events and triggers the operation of the trainer based on the received inputs. The trainer performs steps to train one or more of the prediction models, or combinations thereof, for use by the prediction and runway engine. The prediction and runway engine uses the trained models or combination of models to perform computations for forecasting and determining the runway of one or more resources. The recommendation engine uses the results of the prediction and runway engine to determine one or more recommendations for configuration, hardware, software and/or other changes to the system which may be passed to any one or more instances of results unit 130₁, . . . , results unit 130_{N}, etc. The results of the recommendation engine may feed back into the event handler to create a closed loop process for ongoing evaluation and re-evaluation of the system.

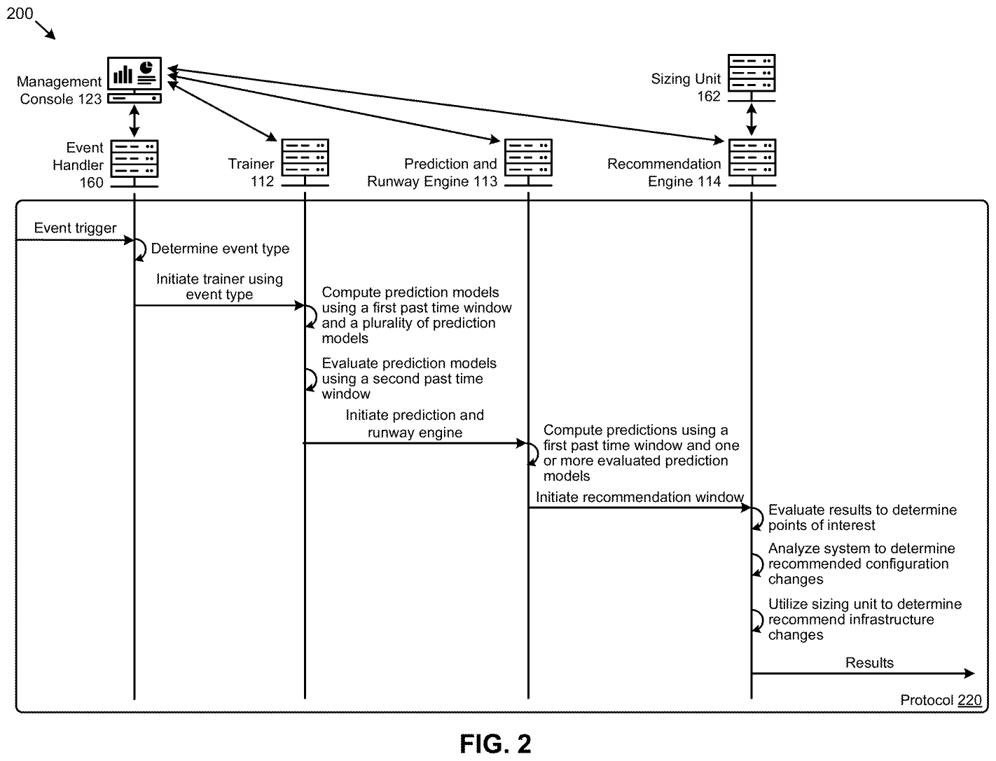

The event handler 111 receives event information and uses that event information to trigger the operation of the trainer 112. Event information may include periodic or otherwise scheduled events and unscheduled events that occur as a results of one or more preset conditions being met. Operation of the event handler 111 are described in further detail below (see FIG. 2).

The trainer 112 executes a tournament. A map reduce operation is performed over a set of data and prediction models. The trainer uses a distributed tournament method to perform time series analysis on a set of user data on which multiple models are trained. The trainer selects, using a distributed map reduce operation, the “best model” or “best models” for the associated user data. Operation of the trainer 112 are described in further detail below (see FIG. 2).

The prediction and runway engine 113 calculates the results for the selected model or models over a time period. The prediction and runway engine iteratively calculate the results of the selected prediction models over a time period. The prediction and runway engine can further identify points of interest 117 such as where a parameter is expected to reach a given usage level or is within a threshold level of being fully used. The operation of the prediction and runway engine 113 is described in further detail below (see FIG. 1D, FIG. 1E, and FIG. 2).

The recommendation engine 114 evaluates the results of the prediction and runway engine to determine any recommended configuration, software, and/or hardware changes to the system. Additionally, in some cases the recommendation engine can use a sizing unit 161 to determine recommendations for hardware and/or software changes, which can be particularly useful for migration of hardware/software between systems and/or for selecting additional/different hardware/software for a given system such as to increase the available runway of one or more resources.

Further details regarding sizing are found in U.S. patent application No. 62/243,643, filed on Oct. 19, 2015, entitled, “METHOD AND APPARATUS FOR DECLARATIVE DEFINITION OF INFRASTRUCTURE COMPONENTS, SOFTWARE, WORKLOADS, AND SIZING RULES FOR A SIZING SYSTEM” (Atty. Dkt. No. Nutanix-056-PROV), which is hereby incorporated by reference in its entirety.

The operation of the recommendation engine 114 is described in further detail herein.

The analytics system 110 may further include a control module 115 and a user interface engine 116 for facilitating a user to interface with the analytics system. For instance, the control module may be used to coordinate the triggering of events by the event handler such as via manual triggering by a user or administrator, by a scheduled triggering event, and/or by monitoring one or more systems for an event of interest such as the addition of a new node to a cluster. The user interface engine provides a means for a user to interact with the analytics system either remotely or via a local instance of the analytics system such as through a traditional application interface or via a user console for remote management of the analytics system.

For instance, the analytics system may be operated via or on a management console such as management console 123, or via user stations or other devices that include any type of computing station that may be used to operate or interface with the analytics system. Examples of such management consoles, user stations, and other devices include, for example, workstations, personal computers, servers, or remote computing terminals, etc., which may also include one or more input devices for the user to provide operational control over the activities of the system such as a mouse or keyboard to manipulate a pointing object in a graphical user interface.

Further, the analytics system may be associated with or operate on one or more clusters such as clusters 150 (e.g., see cluster 150₁, cluster 150₂, . . . , cluster 150_{N}). The one or more clusters may be managed via a management application 105. The management application may implement techniques for the analytics system to interface with the one or more clusters, and/or may provide or implement techniques to facilitate operation of the analytics system on a cluster, which in turn may be accessed remotely via another user station or management console. For instance, the management application may enable the analytics system to access one or more databases on one or more clusters for retrieval and storage of data.

The analytics system may interface with a one or more databases such as database 120 that contain the location(s) for storing and/or retrieving relevant inputs and/or outputs. The database may comprise any combination of physical and/or logical structures as is ordinarily used for database systems such as hard disk drives (HDDs), solid state drives (SSDs), logical partitions, and the like. Here, database 120 is illustrated as a single database containing codifications (e.g., data items, table entries, etc.) of usage data 121 and system and configuration data 124, however the present disclosure is not so limiting. For instance, as discussed above, the database may be associated with a cluster that is separate and distinct from the analytics system. Furthermore, the database may be accessible via a remote server and/or the database or may include multiple separate databases that contains some portion of the usage data and/or system and configuration data.

Usage data 121 comprises data that represents the usage of the resources of the system or systems to be evaluated, and usage data may be stored jointly or separately on one or more databases or on a single database such as the database 120, as illustrated.

System and configuration data 124 comprises data that represents the functions and configuration of the resources of the system to be evaluated, and system and configuration data may be stored jointly or separately on one or more databases or on a single database such as the database 120, as illustrated.

Furthermore, usage data and system/configuration data may be store separately as illustrated, or may be stored jointly. As is discussed more fully below, the analytics system uses some or all of the usage data and system and configuration data to generate, train, predict, recommend, and otherwise output results. The output results of the analytics system may be stored, displayed, or otherwise used locally or remotely.

In some embodiments the analytics system may operate within a virtualized environment where the analytics system may automatically identify usage data and system configuration data from the virtualized environment.

In some embodiments the analytics system may be operated by a management console for a plurality of virtualized network environments. In some cases the analytics system may further identify usage data and system and configuration data from the virtualization environments themselves, and/or may recommend migration of infrastructure and workloads between the virtualization environments.

Details regarding methods and mechanisms for implementing the virtualization environment are described in U.S. Pat. No. 8,601,473, Attorney Docket No. Nutanix-001, entitled “ARCHITECTURE FOR MANAGING I/O AND STORAGE FOR A VIRTUALIZATION ENVIRONMENT” which is hereby incorporated by reference in its entirety.

FIG. 1C presents an example of a user interface 1C00 for interacting with systems that perform seasonal time series analysis and forecasting using a distributed tournament selection process. As an option, one or more variations of user interface 1C00 or any aspect thereof may be implemented in the context of the architecture and functionality of the embodiments described herein. The user interface 1C00 or any aspect thereof may be implemented in any environment.

The example user interface 1C00 is merely one embodiment. Outputs from the shown results unit are displayed in the performance summary window 152. In addition to the performance summary items, a recommendation review window 154 is provided. Recommendations might pertain to the predicted performance of the measured system. For example, recommendations might include adding new nodes to the system and/or adding additional solid state storage. Interactive widgets (e.g., an “Expand” button) might be included so as to facilitate administrative procedures for initiating the expansion.

As earlier indicated, forecasted performance and recommendations that emerge from forecasting operations rely in part on forecasting models. There may be many possibilities for such models, and some of such models may be more applicable than other models. Techniques to train, evaluate and select a “better model” from a set of given models are shown and described as pertains to FIG. 1D.

FIG. 1D depicts a system 1D00 for performing time series analysis and forecasting using a distributed tournament selection process. At operations 172, plurality of prediction models are trained in parallel. The training operations take as input a series of values of a particular parameter of interest in the form of a first time series (e.g., over the first time series 171). Performance of operations 172 produces a plurality of trained prediction models, which are used as inputs for an evaluator. At operations 174, the plurality of trained prediction models are evaluated in parallel as pertaining to the particular parameter of interest using a second time series (e.g., over the second time series 173). Performance of operations 174 produces a plurality of evaluated prediction models. Within operations 176, the plurality of evaluated prediction models are used as input for parallel section of one or more of the evaluated prediction models to produce at least one selected prediction model 177. The selected prediction model 177 or models are used as an input to a time series generator 129. The time series generator 129 serves to forecast expected values for the parameter over a future time period. Specifically, a future time period specification 175 is used for generating a predicted time series 133 for the parameter of interest by calculating a plurality of expected values for the parameter using the selected one or more of the plurality of evaluated prediction models.

As earlier indicated, forecasted performance and recommendations that emerge from forecasting operations rely in part on forecasting models. There may be many possibilities for such models, and some of such models may be more applicable than other models. Techniques to train, evaluate and select a “better model” from a set of given models are shown and described as pertains to FIG. 1E.

FIG. 1E depicts a system 1E00 for performing time series analysis and forecasting using a distributed tournament selection process. As an option, one or more variations of system 1E00 or any aspect thereof may be implemented in the context of the architecture and functionality of the embodiments described herein. The system 1E00 or any aspect thereof may be implemented in any environment.

As shown, the system 1E00 receives a plurality of measurements that have been or can be organized into a time-ordered series of measurements (e.g., selected measurement series 109₁, selected measurement series 109_{N}, etc.). The received measurements are used to form a time series data set pertaining to a particular parameter (e.g., a system parameter such as memory usage, CPU usage, IO usage, IO latency, etc.). For example, selected measurement series 109₁ can be converted from one representation into another representation (e.g., see measurement conversion engine 125). A first set of system parameter measurements (e.g., CPU usage) can be recast into a first time series data set such as the shown time series data set 122₁₁ (see TS1(P1)). Concurrently, or at another time, a second set of system parameter measurements pertaining to the same system parameter measurements (e.g., CPU usage) can be recast into a second series such as the shown time series data set 122₂₁ (see TS2(P1)).

Also as shown, a first time series data set for a particular parameter is used for training a plurality of prediction models. The prediction models can be any of a variety of known mathematical models (e.g., ARIMA, ETS, STL, THETA, TBATS, etc.), neural networks, random walk models, seasonal naïve, mean and/or linear regression models, etc. In exemplary scenarios, prediction models include several of the aforementioned mathematical models and, using a system that includes parallelized trainers (e.g., trainer 112₁, trainer 112₂, trainer 112_{N}), any number of such mathematical models can be trained in parallel so as to produce a plurality of trained prediction models (e.g., model 118_{1T}).

The plurality of trained prediction models have been thusly trained using the first time series data set pertaining to the first parameter. Each or any or all of such trained prediction models can be evaluated in parallel (e.g., by concurrently running instances of data set evaluator 119₁, data set evaluator 119₂, . . . , data set evaluator 119_{N}, etc.) using parameter data captured over a second time series. Such evaluation generates evaluated prediction models which are provided to a model selector 127. A model selector considers a variety of characteristics of the plurality of evaluated prediction models (e.g., using built-in heuristics and/or using configuration data) so as to select one or more of the plurality of evaluated prediction models based on applicability and/or accuracy criteria. When at least one of the plurality of evaluated prediction models have been selected, the system 1E00 uses the selected model to generate a predicted time series data set for the parameter. In the system shown, a time series generator 129 calculates a plurality of expected values for the parameter (e.g., predicted time series 133) using the selected one or more of the plurality of evaluated prediction models.

A time series specification generator 139 can be used in combination with the prediction and runway engine. Strictly as one example, any instance of a time series generator 129 can calculate a time series of expected values for a selected parameter as specified by the time series specification generator. Such a time series specification can receive and/or analyze and/or produce a selected system parameter 141 as well as a selected forecasting period 143.

A system such as system 1E00 can be partitioned such that the functions provided by individual components can be deployed into operational units (e.g., processes, tasks, threads, virtual machines, containers, etc.) that can interact in accordance with a predefined protocol. Aspects of such a protocol are provided in the ladder diagram of FIG. 2.

FIG. 2 presents a ladder diagram 200 of a protocol for performing seasonal time series analysis and forecasting using a distributed tournament selection process. As an option, one or more variations of ladder diagram 200 or any aspect thereof may be implemented in the context of the architecture and functionality of the embodiments described herein. The ladder diagram 200 or any aspect thereof may be implemented in any environment.

The embodiment shown in FIG. 2 is merely one example. FIG. 2 illustrates a protocol 220 used in an analytics system. As shown, the analytics system operates in a multi-stage pipeline of operations. In a first stage the event handler 160 will initiate the trainer based on an event trigger. In a second stage the trainer 112 will train and evaluate a plurality of prediction models using a first past time window and a second past time window. In a third stage the prediction and runway engine 113 iterates through the trained models over a period of time. In a fourth stage the recommendation engine 114 evaluates the results of the prediction and runway engine to determine what, if any, recommendations should be made.

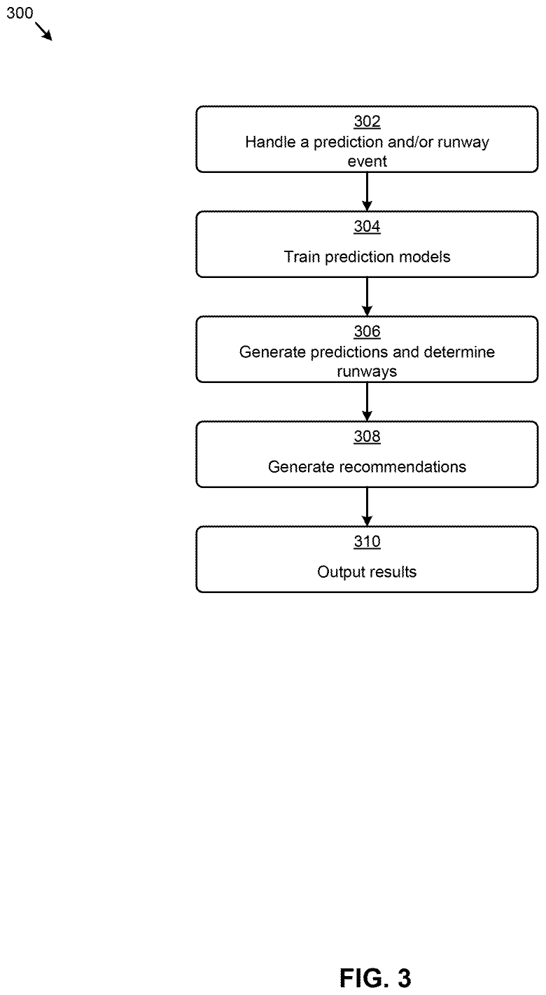

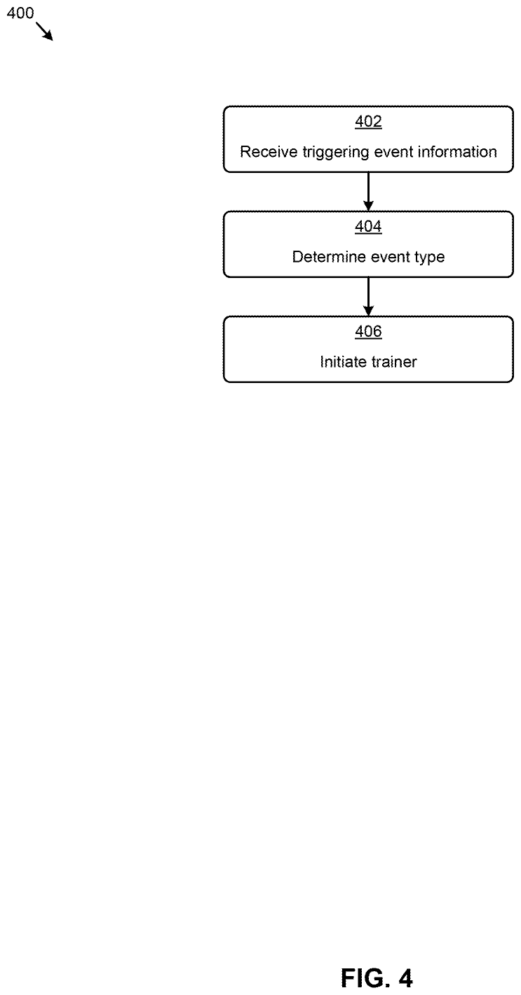

The event handler 160 as illustrated in FIG. 2 receives an event trigger as an input. Using the event trigger, the event handler will determine the type of the event and initiate the trainer 112. Trigger events may include scheduled events such as periodic verification of the state of the system and/or individual system resources. Other trigger events may include events such as when a condition is met such as addition or removal of a component. Trigger events may also include events triggered by a user or administrator such as when the user may wish to perform predictions for one or more parameters on demand. Trigger events may be scheduled at periodic intervals such as daily, weekly monthly, or any other frequencies. Trigger events may also include events that occur on a non-periodic or random frequency such as upgrading or downgrading one or more components of a system and/or adding/removing/updating software, or may be triggered automatically when any of these events occur. Triggering events may be issued when an individual resource or combination of resources reach a specific usage level such as when the storage space usage is at or above some threshold such as 80%. Any of a wide variety of monitoring systems, programs, devices, or logic can be used to trigger an event such that any foreseeable occurrence can be used as a mechanism for triggering an event. Further details regarding the event handler are provided below at least in association with the discussion of FIG. 3 and FIG. 4.

Trainer 112 is initiated by the event handler 160. The trainer trains a plurality of prediction models using a first past time window and compares the prediction models over a second past time window. Training of an individual prediction model may be completed through any known method. As heretofore shown and described, the present technique leverages a plurality of systems to train a plurality prediction models over one or more past time windows in parallel.

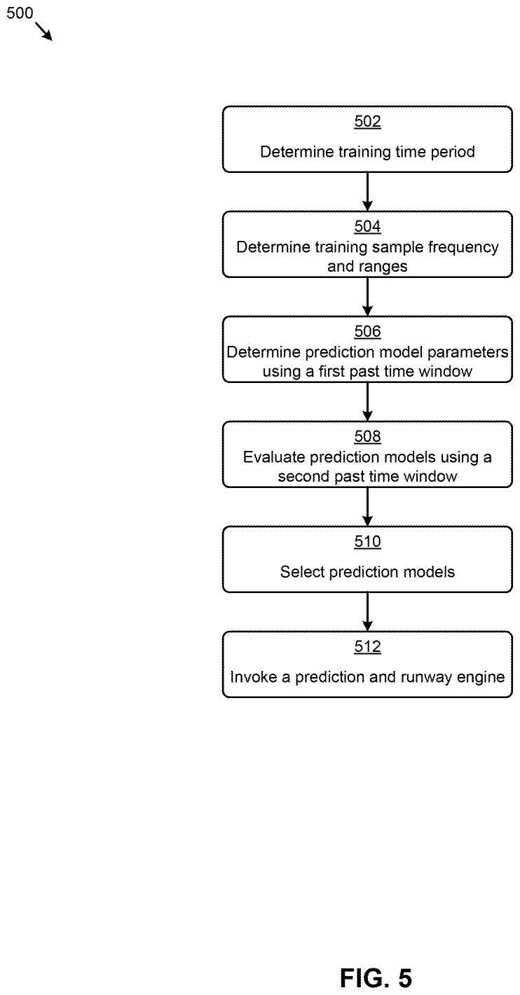

Specifically, the present technique uses a tournament to evaluate individual prediction models on one or more past time windows of data, and then uses one or more map reduce functions to select the one or a plurality of prediction models that best predict a second time window. This allows one or a plurality of prediction models to be selected and aggregated, or reconciled, to create an individual prediction model that may contain elements of a plurality of models. Furthermore, the past time window may be sampled at different frequencies such as at a short interval for selecting a prediction model for a short term time period, or at a medium term interval for selecting a prediction model for a medium term time period, or at a long term interval for selecting a prediction model for a long term time period. Additionally, individual prediction models for differing time periods may be analyzed in relation to each other such as when a model is selected because it does the best overall for all intervals, or selecting the model that does the best for each interval and aggregating those models together to create a single hybrid model. Such techniques provide prediction models that can be dynamically selected using actual usage data, and can be selected from a group of models or aggregation of models as circumstances dictate. Further details regarding the trainer are provided below at least in association with the discussion of FIG. 3 and FIG. 5.

The prediction and runway engine 113 is initiated by the trainer 112. The prediction and runway engine provides the elements necessary to iterate through one or more prediction models, either as aggregates or separately. Generally, the prediction engine evaluates and computes the values of one or more trained prediction models. This occurs by iterating through the prediction models at a given interval to determine the relevant values at a number of points.

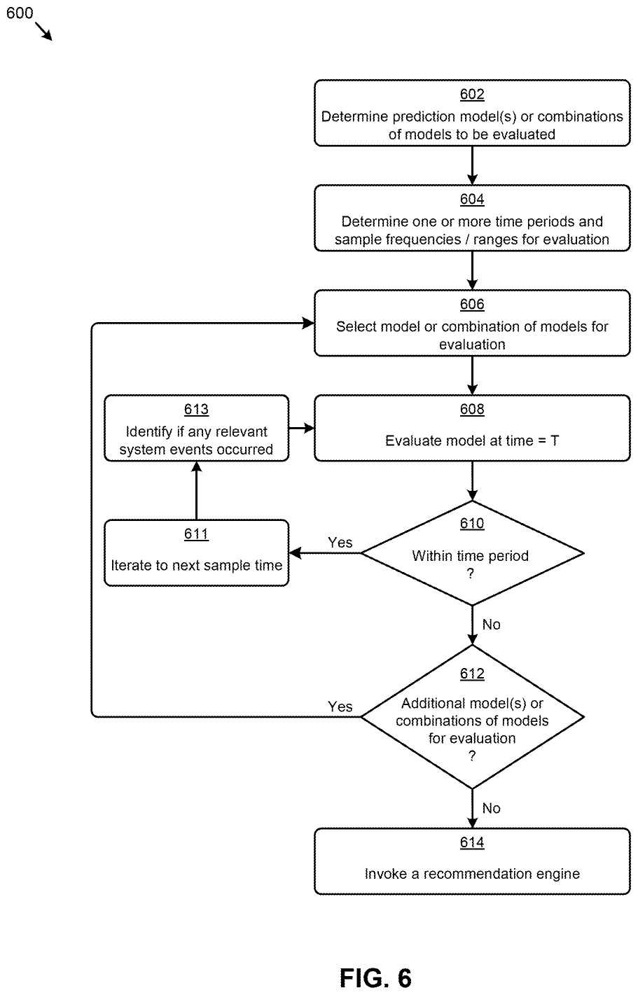

For instance, each prediction model can be evaluated annually, biannually, quarterly, monthly, weekly, daily, hourly, or at any other desired frequency. Furthermore, the time period can be determined using a runway. For example, an aggregated prediction model used to predict non-volatile storage availability can be used to determine the runway for that resource. The prediction model can then be evaluated up until the point where the predicted amount of non-volatile storage used is equal to or greater than the amount of non-volatile storage used, at which point the runway is equal to the amount of time from the present to the point where it is predicted to be no more non-volatile storage available and no further iterations are required. Furthermore, various modifications can be made to the determination of when to stop iterating such as computing the runway plus some offset of additional computations or time period, or computing the runway up to a maximum time period such that computation will stop even if the runway has not been found, or computing the runway up until the point when it is determined that resource utilization is decreasing for some minimum period of time. These variations would serve to limit unnecessary computation and provide more complete predictions without overusing the computational resources. Further details regarding the prediction and runway engine are provided below at least in association with the discussion of FIG. 3 and FIG. 6.

The recommendation engine 114 is initiated by the prediction and runway engine 113. The recommendation engine identifies relevant points of interest 117 (see FIG. 1B) and, using the available information for those points of interest, provides recommendations to a user or administrator to extend or improve the functionality of the system.

For instance, relevant points of interest might include the point where one or more resources are consumed or have reached a usage threshold. Other points of interest might include system status information that can trigger the enabling or disabling of one or more features such as compression, de-duplication, or a change in the amount of redundancy. Given some points of interest, the recommendation engine may then analyze the system to determine any recommended configuration changes such as reconfiguring software, enable operating system features, or other changes. The recommendation engine may use any appropriate sizing unit 162 such that the recommendation engine may provide as inputs the predicted future values and/or requirements to the sizing unit to size the future system and/or to provide recommendations on how to modify the present system. In this way the recommendation engine may provide recommendations on how to maintain a system that will meet the users' and/or administrators' needs for some designated time period. For instance, the system may provide recommendations for 6 months, a year, or some other time period such that projections and/or other planning can occur using prediction generated from actual data to determine what changes and expenses should be incurred and when.

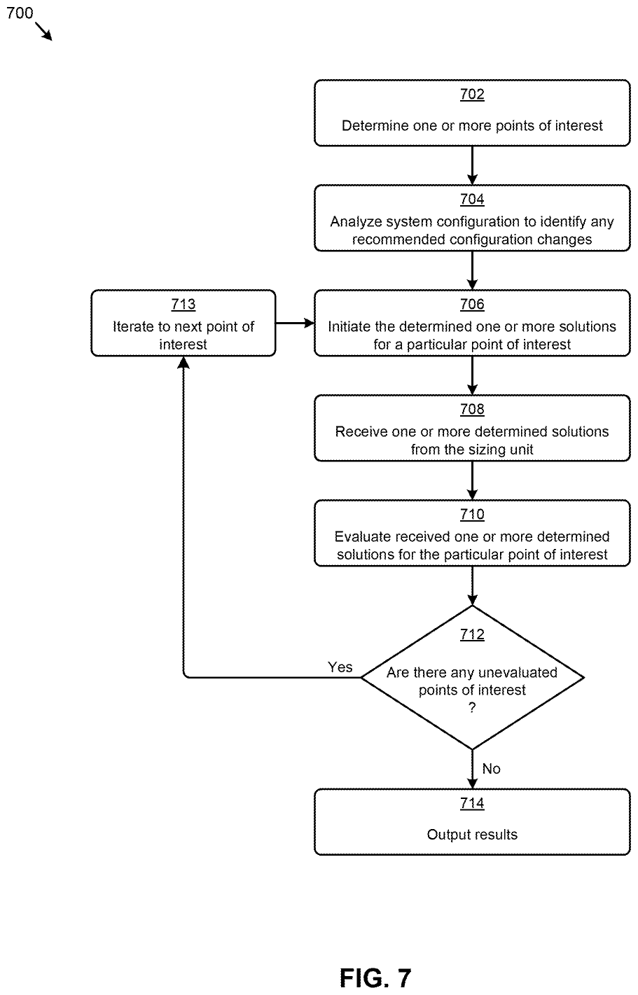

Details regarding a particular method and mechanism for implementing a sizing unit is described in U.S. Patent Application No. 62/243,643, filed on Oct. 19, 2015, Attorney Docket No. Nutanix-056-PROV, entitled “METHOD AND APPARATUS FOR DECLARATIVE DEFINITION OF INFRASTRUCTURE COMPONENTS, SOFTWARE, WORKLOADS, AND SIZING FORMULAS FOR SIZING SYSTEM”, which is hereby incorporated by reference in its entirety. Further details regarding the recommendation engine are provided below at least in association with the discussion of FIG. 3 and FIG. 7.

A management console 123 may be used to interface with and control the various aspects of the system. For instance, the virtualization management console may be used to set up scheduled events or conditions for when an event is triggered. Furthermore, the virtualization management console may be used to specify what parameters, frequency, and time periods an administrator or user may want to analyze such that the various parts of the analytics system operate over the desired time period and for the desired parameters. For example, a user may schedule a complete system analysis including generating predictions and runways for major components such as CPU and non-volatile storage, and recommendations for maintaining a 20% excess capacity in CPU availability and a 30% excess capacity in non-volatile storage. Furthermore, the user can schedule daily evaluations of same without retraining the prediction models every day but Sunday. Such data can then be used to collect data for generating reports, and for a closed loop system monitoring process such that trend information over time can be used to compare the results from previous prediction models and the actual data collected, and ultimately feed that information back into the trainer 112 such that an adjustment can be made for prediction models that have been consistently over forecasted or under forecasted.

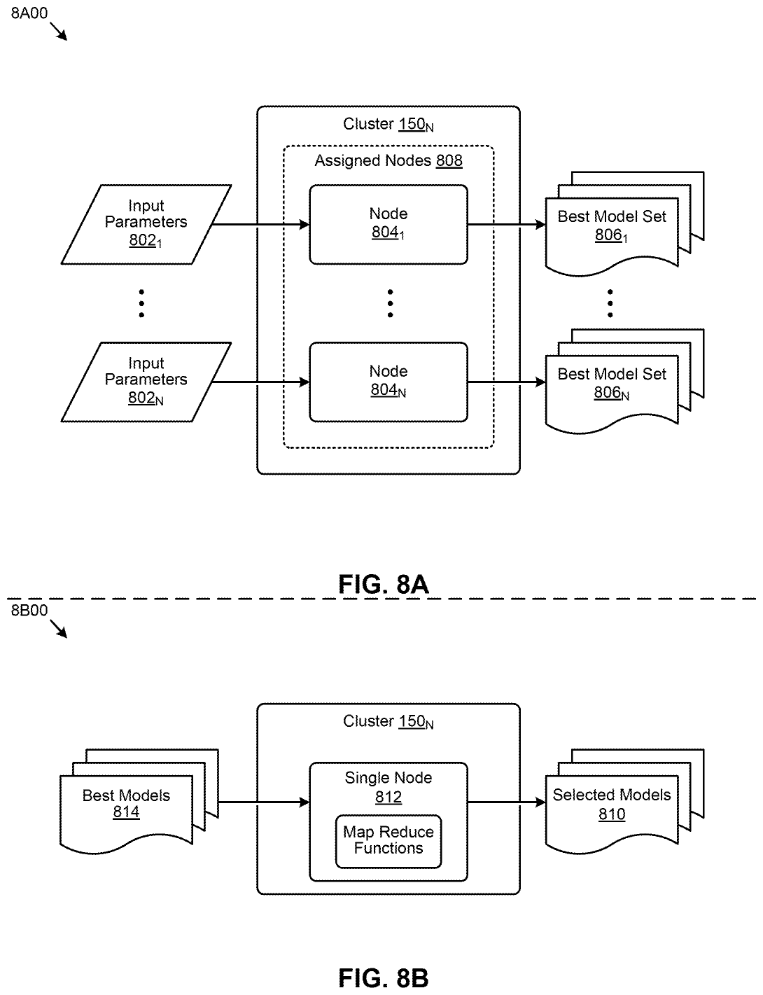

In some embodiments, and as discussed above in regard to FIG. 1B, the analytics system may be operated remotely. In addition, the analytics system may operate across one or more systems. For instance, the event handler, trainer, prediction and runway engine, and recommendation engine can operate on different systems. Moreover, the trainer itself may use multiple different systems to distribute the workload for the training operation. Specifically, the trainer uses a distributed tournament selection process across multiple systems and one or more map reduce functions to enable the system to train multiple predictions models and evaluate those models over one or more sets of data. Further details regarding the tournament and map reduce functions are provided infra in association with at least FIG. 8A and FIG. 8B.

FIG. 3 presents an operation flowchart that describes a technique 300 for performing seasonal time series analysis and forecasting using a distributed tournament selection process. As an option, one or more variations of technique 300 or any aspect thereof may be implemented in the context of the architecture and functionality of the embodiments described herein. The technique 300 or any aspect thereof may be implemented in any environment.

The embodiment shown in FIG. 3 is merely one example. FIG. 3 illustrates a flowchart of the operation of the analytics system in accordance with some embodiments. Various aspects of the embodiments may be implemented separately or may be implemented as a whole.

The process generally includes the occurrence of a prediction and/or runway event which may initiate the training of the prediction models, generation of predictions and determination of runways, and generation of recommendations and outputting results. However, in certain circumstances some steps may be omitted. For instance, when the prediction models have been recently trained the process may skip the step of training (or retraining) the prediction models.

The process starts with the handling of a prediction and/or runway (or triggering) event 302. As discussed previously, trigger events may include scheduled and unscheduled events, or may include events based on the status of a system. Such events enable a user to use the system in an automated, semi-automated, or manual fashion. Further details regarding the operation of the event handler is provided infra in association with at least FIG. 4.

The process continues at step 304, where the analytics system trains prediction models. As discussed previously, training of prediction models includes a distributed tournament model where multiple prediction models are trained over one or more past time windows, and where one or more best prediction models, or some combination thereof, are selected for a given time period or periods. The disclosed method discussed below in regard to FIG. 8A and FIG. 8B provides the flexibility to determine the prediction model or models using actual usage data for the system as opposed to being predetermined by either the software package or the function. Further details regarding training of prediction models is provided infra in association with at least FIG. 5.

The process continues with at step 306, where the analytics system generates predictions and determines runways. As discussed previously, generating predictions and determining runways includes iterating through one or more prediction models such that a series of values are determined for one or more characteristics for some period of time, when some condition is met, or any combination thereof. A user interface facilitates a user to evaluate one or any number of characteristics to determined predictions for system usage at some future time period. Further details regarding generating predictions and determining runways is provided infra in association with at least FIG. 6.

The process continues with at step 308, where the analytics system generates recommendations. As discuss previously, generating recommendations includes generating recommendations for configuration changes, hardware changes, software changes or some combination thereof. Furthermore, and as previously discussed, the recommendation engine may use any appropriate sizing unit to provide recommendations for extending the runway of one or more resources. This facilitates evaluation of the recommendations such that an administrator can plan purchases and other work according to the predictions generated using the usage data from the system itself. Further details regarding generating recommendations is provided infra in association with at least FIG. 7.

The results may be output at step 310 to a database, virtualization management console, reporting mechanism, or other location. As discussed previously, the data collected from previous predictions and runway determinations can be compared to the actual values that later resulted, and can be used to further tune or adjust one or more prediction models.

FIG. 4 presents a flowchart of a triggering technique 400 as used in systems that perform seasonal time series analysis and forecasting using a distributed tournament selection process. As an option, one or more variations of triggering technique 400 or any aspect thereof may be implemented in the context of the architecture and functionality of the embodiments described herein. The triggering technique 400 or any aspect thereof may be implemented in any environment.

The embodiment shown in FIG. 4 is merely one example. FIG. 4 illustrates a flowchart of the operation associated with the handling of a prediction and/or runway event in accordance with some embodiments. However, various aspects of the embodiments may be implemented separately or as a whole.

The process generally comprises receiving triggering event information, determining the event type using the triggering event information, and initiating a trainer based on the event type. The event handling process facilitates scheduling of events and/or can facilitate raising or initiating events on demand. For instance, a user can provide any number of rules that specify when a particular occurrence comprises an event, and what information is associated with those events. Furthermore, a software provider can provide the same thing as a way of providing default or recommended monitoring, whether schedule- or event-based, such that installation of a software provider modules also provides automated monitoring for that software and/or other software and/or systems.

The triggering event information received at step 402 may include an event type. For instance, a prediction and determination request for the current non-volatile storage runway and associated information such as the relevant system on which the predictions are to be performed may be used as or in conjunction with a triggering event, which may in turn have an associated event type. The triggering event information may also include one or more system status parameter thresholds such as a specified threshold for the available storage space in a storage pool, or a CPU usage threshold for some minimum period of time.

The process continues when the event type is determined at step 404. Such a determination would indicate the type of prediction or predictions requested, and may include specifications on how to select the prediction model such as by selecting a best all-around model, an aggregate model, the best three models, or some combination or variation thereof. In this way a user can use prediction models that best suit their needs. Furthermore, in another embodiment, the event type determined may include default or preset values for indicating various parameters such as time range, runway calculations, and time frames for requested recommendations.

The process continues by initiating a trainer at step 406. Such an initiation includes processing the preference information received regarding the triggering event type and any corresponding preferences associated with that event type. In this way a system can be configured to perform predictions and/or runway computations in response to one or more events, whether scheduled or otherwise.

FIG. 5 presents a flowchart of a prediction model training technique 500 as used in systems that perform seasonal time series analysis and forecasting using a distributed tournament selection process. As an option, one or more variations of prediction model training technique 500 or any aspect thereof may be implemented in the context of the architecture and functionality of the embodiments described herein. The prediction model training technique 500 or any aspect thereof may be implemented in any environment.

The embodiment shown in FIG. 5 is merely one example. FIG. 5 illustrates a flowchart of the operation of training prediction models in accordance with some embodiments. However, various aspects of the embodiments may be implemented separately or as a whole.

The training process generally includes a determination of the time period on which to train, a sample frequency or ranges on which to train, a determination of prediction model parameters based on a first past time window, an evaluation of those prediction models using a second past time window, and selection of one or more models or combinations of models using one or more map reduce functions. This process allows for distribution of model training and for selection of the models leveraging a distributed process, thereby providing an administrator or user with a tool that can select a best fit model or combination of models based on actual data on a real time basis.

The process begins by determining the training time period at step 502, which corresponds to a past time window. The past time window may be a single time window, or there may be multiple past time windows or may be multiple different time windows. For instance, time windows may correspond to data for each individual node of a cluster. For purposes of the discussion, a single time window is discussed infra, with further variations being discussed in regard to FIG. 8A and FIG. 8B.

The process continues by determining a training sample frequency or ranges at step 504, where the training data may be sampled at a determined frequency (such as every second, minute, hour, day, week, etc.) and used for training the prediction model or, in the alternative, the training data may be sampled based on ranges where segments within the data set are themselves represented by equations and then evaluated at different points as represented by those equations. In some embodiments, this may include preprocessing of data to remove heteroscedasticity or to fill in missing data. For instance, a check may be performed to determine if the data exhibits heteroscedasticity using White's test and, if so, the Box-Cox transform may be used on the training data. After predictions on the transformed data are generated, any known techniques can be applied to the predictions to assess heteroscedasticity. With regard to missing data (as can commonly occur), estimated values may be determined based on neighboring values such as by averaging, by an exponential model, or other known interpolation methods.

The process continues at step 506, where the prediction model parameters are determined using the first past time window. Any suitable approach can be used to remove noise/randomness, adjust for seasonality, and otherwise fit the model to the data. However, as is discussed further in regard to FIG. 8A and FIG. 8B, the present disclosure contemplates a tournament training and evaluation process. Furthermore, in some embodiments, individual models may be selected or removed from consideration based on various characteristics of the data. For instance, initially, or at any point during training, a model may be dropped from consideration if, for instance, an abrupt change in trend or seasonal data is identified according to known techniques such that a model is presumed to provide less then acceptable results.

The process continues at step 508, where the prediction models are evaluated with respect to a second past time window. Preferably the first time window and the second time window represent a contiguous period of time where the first time window precedes the second time window. Details regarding evaluation of the prediction models is discussed infra in association with at least FIG. 8A and FIG. 8B.

The process continues at step 510, where the trained and evaluated prediction models are compared over one or more time periods and where the best model set of models is selected (e.g., using a map reduce operation). Further variations of this process are discussed in regard to FIG. 8A and FIG. 8B, including the tournament process itself used to select the prediction models including individual prediction models, aggregated prediction models, or a set of prediction models to be used.

The process continues at step 512, where an instance of a prediction and runway engine is invoked.

FIG. 6 presents a multi-model evaluation technique 600 as used in systems that perform seasonal time series analysis and forecasting using a distributed tournament selection process. As an option, one or more variations of multi-model evaluation technique 600 or any aspect thereof may be implemented in the context of the architecture and functionality of the embodiments described herein. The multi-model evaluation technique 600 or any aspect thereof may be implemented in any environment.

The embodiment shown in FIG. 6 is merely one example. FIG. 6 illustrates a flowchart of the operation of generating predictions and determining runways in accordance with some embodiments. However, various aspects of the embodiments may be implemented separately or as a whole.

The process includes receiving the prediction model, models, or combination of models to be evaluated, determining the time over which to evaluate the models, and iterating through the models over a time period. In this way one or more models or combination of models can be evaluated to predict future use and determine available runways.

The process starts at step 602, where the models to be evaluated are determined. Such models may be transmitted to the prediction and runway engine from the trainer, or may be retrieved from a database. The process may further generate a list, queue, or other database structure to hold the models or combinations thereof to be evaluated. This information is then updated, at step 604, to include the time periods and sample frequencies or ranges for evaluation. Furthermore, in some embodiments, the time periods may be determined by one or more rules that specify whether further evaluation should be performed or whether one or more conditions have been met to halt further evaluation of the model or combinations thereof.

The process continues at step 606, where a model or set of models are selected for evaluation. The individual models or combinations thereof can be evaluated serially. However, the process may select multiple models or combinations thereof for evaluation and initiate the evaluation of each model in a parallel manner. For instance, a networked virtualization environment may be leveraged to initiate multiple concurrent but independent threads to evaluate each individual set of models. In this way, the number of different models evaluated may increase with the size of a cluster without increasing the amount of time to analyze such models beyond the time to analyze the most computationally expensive model for the individual models if they were serially evaluated.

Evaluation of each individual model begins at step 608, where the value of the model is determined at a time T and stored either temporarily or in a database. In the first instance an initial start time is determined, which is generally the current time, although a user can modify this if desired. Additionally, the evaluation process may trigger one or more tests to determine whether a predicted value is at or above a given threshold. If the determination finds that the predicted value is at or above the threshold, an entry would be made in the database specifying a point of interest for future evaluation in the recommendation stage. At decision 610, a test is performed to determine if the time T is within the prediction time period and/or within the runway period (e.g., as determined by a value or according to one or more rules). If so, the process will continue iterations at step 611 to process the next sample point (e.g., at a new time T).

At step 613, the predicted values may be analyzed to determine whether an event may occur that would affect future usage of a resource. For instance, analysis may indicate that as available disk space decreases, a de-duplication process will stop, at which point the rate at which the available storage capacity that is used may increase. As a result, the model may be adjusted to compensate for the increased use by, for instance, adding an offset or weighting to the determined value to account for the increased storage space usage, or some other modification of the prediction model. The process continues to iterate through step 606, step 608, decision 610, step 611, and step 613 until it is determined that the current prediction time is no longer within the specified time period.

The process continues at step 612, where it is determined if any additional models or combinations thereof are remaining for evaluation. In this way, all the determined models may be evaluated in parallel, or in multiple rounds of parallel evaluations. When it is determined that there are no more models or combinations thereof for evaluation, the process will invoke the recommendation engine, at step 614, which may include passing the results via a storage mechanism or over one or more local or networked interfaces.

FIG. 7 presents a multi-solution evaluation technique 700 as used in systems that perform seasonal time series analysis and forecasting using a distributed tournament selection process. As an option, one or more variations of multi-solution evaluation technique 700 or any aspect thereof may be implemented in the context of the architecture and functionality of the embodiments described herein. The multi-solution evaluation technique 700 or any aspect thereof may be implemented in any environment.

The embodiment shown in FIG. 7 is merely one example. FIG. 7 illustrates a flowchart of the operations for generating recommendations in accordance with some embodiments. However, various aspects of the embodiments may be implemented separately or as a whole.

The process includes identification of one or more points of interest and evaluation of the system to determine any possible recommended solutions including configuration changes of all types. In this way, the predictions and runway calculations can be leveraged to provide recommendations for the user or administrator such that they can take appropriate actions to provision one or more systems for the expected workload over the desired period.

The process starts at step 702, where one or more points of interest are identified (e.g., determined or received from previous processes). Points of interest can be those identified and stored during the foregoing processes. However, in some embodiments, a user can also set preferred or default points of interest at any number of given points, thereby setting up a number of points in time for the system or systems to be evaluated at, regardless of whether any other predicate condition has been met.

The process continues at step 704, where an initial analysis of the system can be performed so as to determine if any recommendations are to be made based on the current system or systems. Some such recommendations can be determined through use of a sizing unit and analysis of results of such a sizing unit (e.g., see step 708, below). Such systems may determine that one or more configuration changes should be made such as a recommendation to enable compression and deduplication to better use the available storage and/or to increase the replication factor to provide a greater level of security for stored data. Furthermore, the analysis can be used as a baseline to determine whether the present system or systems are configured according to industry best practices guidelines and/or other guidelines.

The process continues at step 706, where the determination of one or more solutions for a first point of interest Y are made. The process is similar to that described in regard to step 704, but here the system or systems are analyzed according to a different set of information. Specifically, here the information used to evaluate the system is based on the configuration of the system and predicted usage information. In this way the system may be sized to provide recommended changes using the expected parameters for any particular point of interest. This process is executed by providing the sizing unit with the information on the current system and with the predicted usage data to receive one or more solutions for maintaining the system at that point of interest.

At step 708, the results of the sizing unit are received, then evaluated at step 710 to determine one or more solutions (or actions to be taken) for that particular point of interest. Specifically, the actions are the delta or difference between the present system and one or more solutions received from the sizing unit which may be stored in a database. In this way a set of possible solutions at a point of interest can be provided such that the user or administrator can be informed of what actions to take to maintain a system to a given standard. Furthermore, the processes can be repeated. As shown, step 712 determines whether there are any unevaluated points of interest by iterating to the next point of interest at step 713. The processing of step 706, step 708, step 710, and step 712 can be repeated in iterations. In this way the process can provide multiple lists or sets of actions that can be taken to maintain a system to a given standard up to each time point associated with each individual point of interest.

In some embodiments, the results may be further filtered and refined at step 714 to provide a more limited set of recommendations to a user or administrator such that the results can be represented in a more manageable fashion via a graphical user interface or other appropriate reporting method. However, in some embodiments, the data may simply be stored or transmitted to a designated location for use at a later time.

FIG. 8A illustrates a local model selection approach 8A00 as used in systems that perform seasonal time series analysis and forecasting using a distributed tournament selection process. As an option, one or more variations of local model selection approach 8A00 or any aspect thereof may be implemented in the context of the architecture and functionality of the embodiments described herein. The local model selection approach 8A00 or any aspect thereof may be implemented in any environment.

The embodiment shown in FIG. 8A is merely one example. FIG. 8A and FIG. 8B illustrate a first approach for tournament selection in accordance with some embodiments. However, various aspects of the embodiments may be implemented separately or as a whole.

The process uses the individual nodes of a clustered virtualization environment to perform training and model selection. Using one or more sets of time series data, each node performs training on the individual prediction models. The models may then be analyzed using one or more map reduce functions to determine which model or models should be selected as better performing. A model or combination of models is selected based on the results of the map reduce functions.

FIG. 8A illustrates the initial tournament arrangement. In the shown tournament processing, each node receives a set of time series data and/or other input parameters (e.g., input parameters 802₁, . . . , input parameters 802_{N}, etc.). The parameters may include the models to train, the time series data over which to train, the time series data over which to evaluate the trained models, and/or the frequency or sample range for the individual parameters. The parameters (e.g., storage pool 10 usage, storage pool 10 latency, etc.) may be transmitted over a network or local link or may be stored on a local storage device associated with a storage pool and/or other storage mechanism. Also, time series predictions pertaining to the storage pool (e.g., storage pool IO usage, storage pool IO latency, etc.) can be transmitted over a network or local link or may be stored on a local storage device associated with a storage pool and/or other storage mechanism.

Each of the assigned nodes 808 (e.g., node 804₁, . . . , node 804_{N}, etc.) will then execute a process to train the indicated models including identification of which variant of a particular model to select, filtering to remove undesirable randomness, a determination if the time series is stationary, a determination if the time series needs to be differenced, identification of any seasonal or holiday components, and/or other appropriate steps to train prediction models.

After training the models, the best model or a set of best models 814 (e.g., best model set 806₁, . . . , best model set 806_{N}, etc.) are selected (e.g., see selected models 810) at each individual node using an initial map reduce step. For instance, the top three performing models from the results of each node may be selected or, as an alternative, the single best model may be selected. The best model may be determined by any appropriate method. For instance, the best model or models can be selected by summing the total deviation of the predicted results from the actual results for a given time window (e.g., whether determined at individual points or by summing the total area between the predicted results and the actual results). Other methods can be used to evaluate the models such as an exponential model that disfavors a larger magnitude of variation in favor of a total magnitude of variation and where the exponent is the difference from the actual and predicted results, or other methods and weightings such as symmetric mean absolute percentage error (sMAPE), mean absolute scaled error (MASE), root mean square error (RMSE), random error (RE), absolute error (AE), etc.

In some embodiments, multiple iterations of the tournament may be performed. For instance, if the number of models or model combinations is greater than the number of nodes, then the tournament may need to execute in multiple rounds. In this case the process may collect the results for later analysis for operation in multiple rounds. For instance, there may be multiple phases where the best models are determined for multiple different time periods such as best week, best month, best 3 months, best 6 months, best year, etc. In this way multiple models can be analyzed to develop an aggregate prediction model.

The training and evaluation process may be used to generate an index such that a best model or models are identified for a particular set of time series data. Furthermore, the index may be a distributed data set such as in a clustered virtualization environment where not one node, but all nodes, may be used to collect such index data thereby populating the index in parallel or concurrently. The index itself is useful for selection of a prediction a model without the execution of a tournament between models. Specifically, the map reduce operation previously discussed comprised a comparison between a set of past time series data and predicted results for that past time period based on an earlier time period. However, using the index and comparing the past time series data to the time series data in the index, the process can be directed to steps for selecting the model or models previously used for the closest matching usage data. In this way a prediction model can be selected by association by determining the best fit between the past time series data and the time series data in the index. Furthermore, the more the system is used to train prediction models, the more data will populate the index, and as a result the prediction models selected via the index will be a closer match to the time series data.

FIG. 8B illustrates a global model selection approach 8B00 as used in systems that perform seasonal time series analysis and forecasting using a distributed tournament selection process. As an option, one or more variations of global model selection approach 8B00 or any aspect thereof may be implemented in the context of the architecture and functionality of the embodiments described herein. The global model selection approach 8B00 or any aspect thereof may be implemented in any environment.

The embodiment shown in FIG. 8B is merely one example. FIG. 8B illustrates a second approach for tournament selection in accordance with some embodiments. This approach is used for selecting the final model or models for use in one or more models or aggregate models. In some embodiments, the approach may be different from the approach for executing the tournament operation. However, in most situations the selection process will use the same clustered virtualization environment as the tournament process.

In some embodiments, a final selection process operates using one or more map reduce functions. As shown, such map reduce function can be processed on a single node 812, where the single node receives a set of best models 814. While such map reduce functions are illustrated within a single node, this single node could operate merely as the final node in a process that selects desired models based on other already completed map reduce operations.

The selection process may be used to issue further tournaments. For instance, in an initial tournament the process may be used to select for the top five models in multiple different time periods (such as a short, a medium, or a long time period), which may correspond to days, weeks, and months or weeks, months, and years, or some other variation of time periods as previously discussed. The selection process may then use the top five models in each period to issue a second tournament that may test every possibly combination that uses one model from each category. The tournament process followed by the map reduce operations would occur twice, resulting in a final selection of the one or more top prediction models that are each an aggregate of multiple prediction models. As one of ordinary skill in the art would understand, a tournament process for model selection delivers unprecedented ability to train and evaluate multiple different models in near real time.

The prediction models may be trained and evaluated on the individual nodes and reconciled to create a cluster level model. For instance, the individual nodes may each train and evaluate a prediction model or models using time series data collected for the individual nodes. Using the results of the training and evaluations, an aggregate model may be generated to represent the predictions for the cluster level. However, a cluster level prediction model may also be generated based on the overall time series data for the cluster. Regardless, in both cases the prediction models for each individual node may have varying levels of accuracy. Therefore, the results of each individual node may need to be weighted so as to favor prediction models that better predicted the actual past time series data usage over lower performing models. Furthermore, in some situations (when the data does not exhibit heteroscedasticity) an ordinary least squares method may provide sufficiently accurate results.

By way of example, assuming a cluster with nodes 1, node2, and node3, one can reconcile the forecasts by rolling up or aggregating those forecasts:

yₜ=Abₜ EQ. 1

where:

$$A = [ \begin{matrix}1 & 1 & 1 \\ 1 & 0 & 0 \\ 0 & 1 & 0 \\ 0 & 0 & 1\end{matrix} ] \qquad EQ . 2$$

Let yₜ be the aggregate of all time series predictions and bₜ be the vector of all bottom level series at time t.

Further, let ŷₙ(h) be the vector of initial h-step forecasts made at time n; βₙ(h) is the expected value of the base level forecasts and εₕ is error term determined during reconciliation. Then, the reconciled forecast is obtained by solving the following equation for βₙ(h) using generalized least squares:

ŷₙ(h)=Aβₙ(h)+ϵₕ EQ. 3

and, getting revised forecasts:

\tilde{y}ₙ(h)=Aβₙ(h). EQ. 4

Here, the model under consideration is:

ŷₕ=Aβₕ+ϵₕ EQ. 5

where:
ŷₕ is the vector of the h-step-ahead base forecasts for the whole hierarchy,
βₕ is the expected value of the future values of the bottom level time series, and
ϵₕ has a zero mean and covariance matrix Σₕ.
   However, it is important to point out that the method of ordinary least squares assumes that there is a constant variance in the errors (i.e., homoscedasticity). Under this assumption that the best unbiased linear estimator (BLUE) for βₕ is:

βₕ=(A^{T}A)⁻¹A^{T}ŷₕ EQ. 6

and the revised forecasts are obtained using:

\tilde{y}ₙ=A(A^{T}A)⁻¹A^{T}ŷₕ EQ. 7

Under certain circumstances the ordinary least squares method is a poor means of reconciliation. Specifically, when the data exhibits heteroscedasticity it violates the assumption that there is constant variance in the errors (homoscedasticity) of the ordinary least squares method, which can be checked for by determining if the data exhibits heteroscedasticity by, for example, using White's test. Therefore, the method of weighted least squares can be used when the ordinary least squares assumption of constant variance in the errors is violated.

To determine weighting, the reciprocal of each variance, σᵢ² is defined as the weight, wᵢ=1/σᵢ², and the matrix W is a diagonal matrix containing these weights:

$$W = ( \begin{matrix}{w}_{1} & 0 & … & 0 \\ 0 & {w}_{2} & … & 0 \\ ⋮ & ⋮ & ⋱ & ⋮ \\ 0 & 0 & … & {w}_{n}\end{matrix} ) \qquad EQ . 8$$

Then the weighted least squares estimate is:

\hat{β}_{WLS}=arg min_{β}Σᵢ₌₁ⁿϵ*ᵢ²=A(A^{T}WA)⁻¹A^{T}wY EQ. 9

and the revised forecast is obtained using:

\tilde{y}ₕ=A(A^{T}wA)⁻¹A^{T}wŷₕ EQ. 10

In this way a weighted forecast can be generated as an aggregation of the forecasts for the individual nodes that make up a cluster, whether weighted or otherwise.

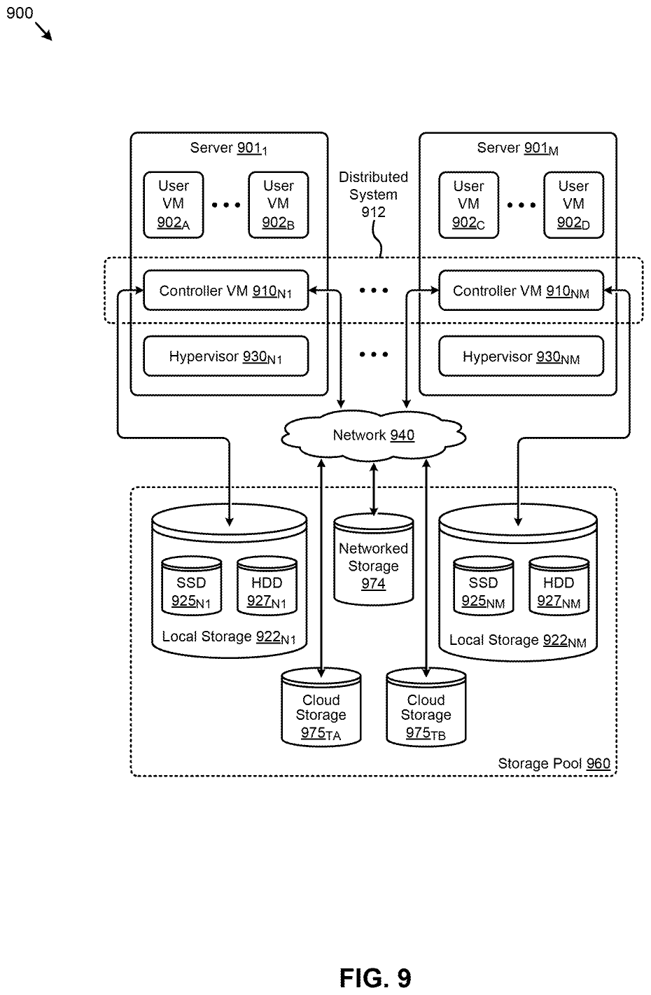

FIG. 9 depicts a clustered virtualization environment 900 as used in systems that perform seasonal time series analysis and forecasting using a distributed tournament selection process. As an option, one or more variations of clustered virtualization environment 900 or any aspect thereof may be implemented in the context of the architecture and functionality of the embodiments described herein. The clustered virtualization environment 900 or any aspect thereof may be implemented in any environment.

The embodiment shown in FIG. 9 is merely one example. FIG. 9 illustrates a clustered virtualization environment in which some embodiments are implemented. One embodiment of the architecture for implementing seasonal time series analysis and forecasting using a distributed tournament selection process is a clustered virtualization environment, and may be interfaced with via a virtualization management console remotely or on the cluster itself. Further, information for and about the cluster may be used as inputs to the training process such that the cluster can be used to perform predictions and runway calculations either for itself or, in the alternative, the cluster may receive inputs from another system or cluster and perform predictions and runway calculations for the other system.

The architecture of FIG. 9 can be implemented for a distributed platform that contains multiple servers (e.g., server 901₁ and server 901_{M})) that manages multiple tiers of storage. The multiple tiers of storage may be implemented as a storage pool 960 that is accessible through a network 940. The storage pool can include storage facilities such as TypeA cloud storage 975_{TA} or TypeB cloud storage 975_{TB} or networked storage 974 such as storage area network (SAN). The shown embodiment also includes local storage (e.g., local storage 922_{N1} and local storage 922_{NM}) that is within or directly attached to the server and/or appliance to be managed as part of the storage pool 960. Examples of local storage can include solid state drives (e.g., SSD storage 925_{N1} and SSD storage 925_{NM}) and/or or hard disk drives (e.g., HDD storage 927_{N1} and HDD storage 927_{NM}).

A collection of storage devices (e.g., local storage, networked storage, and cloud storage) form the shown storage pool 960. Virtual disks (vDisks) can be structured from the storage devices in the storage pool 960. As used herein, the term “vDisk” refers to the storage abstraction that is exposed by a virtualized controller (e.g., controller VM 910_{N1}, controller VM 910_{NM}) to be used by a user VM (e.g., user VM 902_{A}, user VM 902_{B}, user VM 902_{c}, user VM 902_{D}). In some embodiments, the vDisk is exposed via an internet small computer system interface (iSCSI) or a network file system (NFS) and is mounted as a virtual disk on the user VM. A virtualized controller can be implemented as a virtual machine, or as a containerized controller.

In the shown embodiment, each server is configured to run virtualization software such as VMware ESXi, Microsoft Hyper-V, or RedHat KVM. The virtualization software may include a hypervisor (e.g., hypervisor 930_{N1}, hypervisor 930_{NM}) that can, in turn, be used to manage the interactions between the underlying hardware and the one or more user VMs that run client software.

The controller VM is used to manage storage and I/O (input/output or IO) activities. Multiple such storage controller VMs coordinate within a cluster to form a single system. The controller VMs are not formed as part of any specific implementations of hypervisors. Instead, the controller VMs run as virtual machines above hypervisors. Two or more controller VMs work together to form a distributed system 912 that manages all the storage resources including the locally attached storage, the networked storage 974, and the cloud storage. Since the controller VMs run above the hypervisors, the current approach can be used and implemented within any virtual machine architecture since the controller VMs can be used in conjunction with any hypervisor from any virtualization vendor.

Each controller VM exports one or more block devices or NFS server targets that appear as disks to the client VMs. These disks are virtual since they are implemented by the software running inside the controller VMs. Thus, to the user VMs, the controller VMs appear to be exporting a clustered storage appliance that contains some disks. All user data (including the operating system) in the client VMs resides on these virtual disks.

Significant performance advantages can be gained by allowing the virtualization system to access and use local (e.g., server-internal) storage as disclosed herein. This is because I/O performance is typically much faster when performing access to local storage as compared to performing access to networked storage across a network. This faster performance for locally attached storage can be increased even further by using certain types of optimized local storage devices such as SSDs.

The system of FIG. 9 supports a variety of approaches for virtualized computing environments using containers. Generally, containers are a type of operating system-level application virtualization, in which the containers run applications in individual execution environments that are isolated from the host operating system and from each other. Some existing systems for running containerized applications include Linux LXC and Docker.

Containers running applications (e.g., containerized applications) have the property of being very fast to get up and running because no guest operating system needs to be installed for the application. The container may interface with the host computer or computers on a network through one or more virtualized network connections, which is managed by a container manager. For example, a web-server container may run a web-server application which is addressed by an IP address assigned to the container. To address or access the web-server container, a user or computer may use the IP address, which is intercepted by a container manager and routed to the container. Because the container is isolated from the host operating system—such as if the container application is compromised (e.g., hacked)—the malicious entity doing the hacking will be trapped inside the container. However, to increase security, a containerized system may be implemented within a virtual machine. In this way, containerized applications can be quickly modified/updated within the container execution environment, and if one or more of the containers is breached, it will not affect the physical host computer because the container execution environment is still behind a virtual machine. Other approaches and configurations are discussed in U.S. patent application Ser. No. 15/173,577, filed on Jun. 3, 2016, Attorney Docket No. Nutanix-053, entitled “ARCHITECTURE FOR MANAGING I/O AND STORAGE FOR A VIRTUALIZATION ENVIRONMENT USING EXECUTABLE CONTAINERS AND VIRTUAL MACHINES”, which is hereby incorporated by reference in its entirety.

The servers implement virtual machines with an operating system that supports containers (e.g., Linux) and VM software. For example, a node or server runs a controller VM as well as a user container. Each of the user containers may run a container image that may be layered to appear as a single file system for that container. For example, a base layer may correspond to a Linux Ubuntu image, with an application execution layer on top of the application execution layer corresponding to a read/write execution environment for applications such as MySQL, webservers, databases or other applications.

In some embodiments, the controller virtual machines are used to manage storage and I/O activities for the user containers. Multiple such controller virtual machines (controller VMs) coordinate within a cluster to form a single system. In this way, the security and robustness of a distributed storage system using virtual machines may be combined with the efficiency and consistency of a container virtualized computing environment.

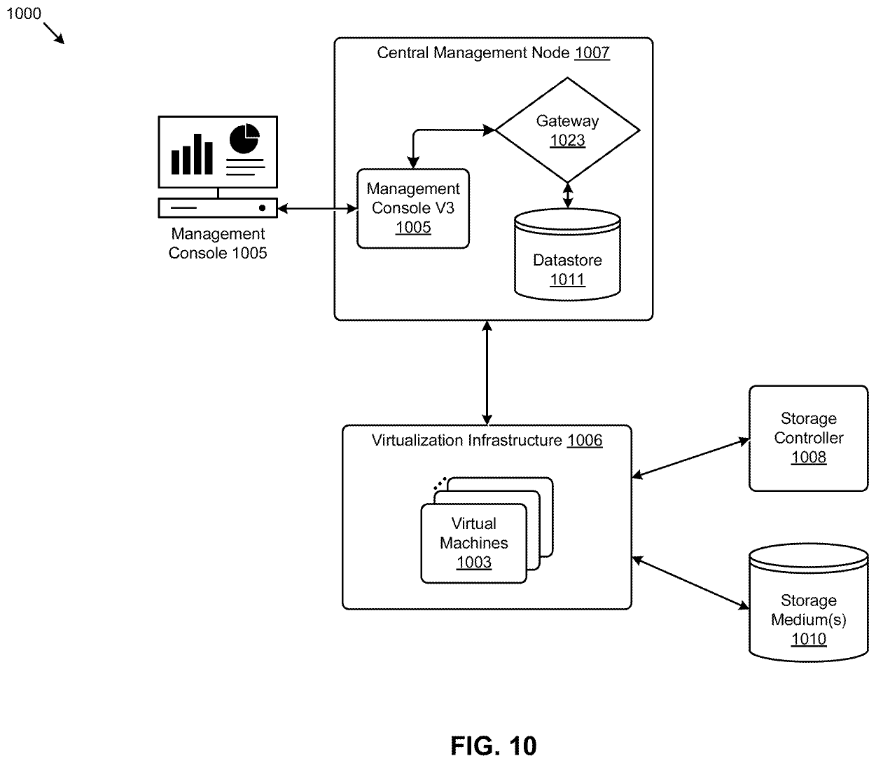

FIG. 10 depicts centralized workload partitioning 1000 in an environment comprising systems that perform seasonal time series analysis and forecasting using a distributed tournament selection process. As an option, one or more variations of centralized workload partitioning 1000 or any aspect thereof may be implemented in the context of the architecture and functionality of the embodiments described herein. The centralized workload partitioning 1000 or any aspect thereof may be implemented in any environment.

The embodiment shown in FIG. 10 is merely one example. FIG. 10 illustrates a system to implement a management console 1005 according to some embodiments of the disclosure. One embodiment of the architecture for implementing the seasonal time series analysis and forecasting using a distributed tournament selection process may operate on a management console 1005 on or within a cluster itself. Further, information for and about one or more clusters may be used as inputs to the training process such that the clusters can be used to perform predictions and runway calculations either for themselves or, in the alternative, the clusters may receive inputs from other clusters and perform predictions and runway calculations for the clusters such that the recommended actions can be provided based on the one or more clusters.

For instance, in some embodiments, the predictions for one cluster may determine that the cluster is over provisioned, and predictions for another cluster may determine that the other cluster is under provisioned, therefore the recommendations might include migration of resources from one cluster to the other. In other examples, the recommendations may include swapping one node or component on one system with that of another, where the swapped nodes or components may increase one capability while decreasing another, such as when one cluster is processor bound and another cluster is storage bound and shifting components may rebalance both clusters advantageously. Furthermore, the individual clusters may execute their own prediction and runway analysis and the management console may control analysis of the results with respect to each console such that it determines any recommended movement of resources from one cluster to another cluster.

Further details regarding general approaches to forecasting are described in U.S. application Ser. No. 15/191,387 entitled, STORAGE INFRASTRUCTURE SCENARIO PLANNING” filed on Jun. 23, 2016, (Attorney Docket No. Nutanix-081) which is hereby incorporated by reference in its entirety.

The shown system supports one or more users at one or more management consoles (e.g., management console 1005) that can be used within the system to operate the virtualization tools. Management consoles may comprise any type of computing station that can be used to operate or interface with the system. Examples of such management consoles include, for example, workstations, personal computers, or remote computing terminals. The management consoles may comprise a display device, such as a display monitor, for displaying a user interface to users at the user station. The management consoles may also comprises one or more input devices for the user to provide operational control over the activities of the system such as a mouse or keyboard to manipulate a pointing object in a graphical user interface.

The shown centralized workload partitioning 1000 includes virtualization infrastructure 1006, comprising any processing components necessary to implement and provision one or more VMs 1003. This may include management components to obtain status for configuring and/or controlling the operation of one or more storage controllers and/or storage mediums 1010. Data for the VMs 1003 are stored in a tangible computer readable devices. The computer readable storage device comprise any combination of hardware and software that allows for ready access to the data that is located at the computer readable storage device. The storage controller 1008 is used to manage the access and operation of the computer readable storage device. While the storage controller is shown as a separate component here, it is noted that any suitable storage controller configuration may be employed. For example, in some embodiments, the storage controller can be implemented as a virtual machine as described in more detail below. As noted in more detail below, the virtualization infrastructure 1006 may correspond to a cluster of multiple nodes that are integrated as a single system.

According to some embodiments, the management console 1005 interfaces with a central management node 1007, either of which comprise a JavaScript program that is executed to display a management user interface within a web browser. In some embodiments, the storage controller exposes an API or GUI to create, read, update, delete (CRUD) data stores.

In some embodiments, a web browser at the management consoles is used to display a web-based user interface. The management console 1005 might employ Javascript code to implement the user interface. Metadata regarding the system is maintained at a datastore 1011, which collects data relating to the virtualization infrastructure 1006, the storage mediums 1010, and/or datastores at the storage mediums. The Javascript code interacts with a gateway 1023 to obtain the metadata to be displayed in the user interface. In some embodiments, the gateway comprises a web server and servlet container (e.g., implemented using Apache Tomcat).

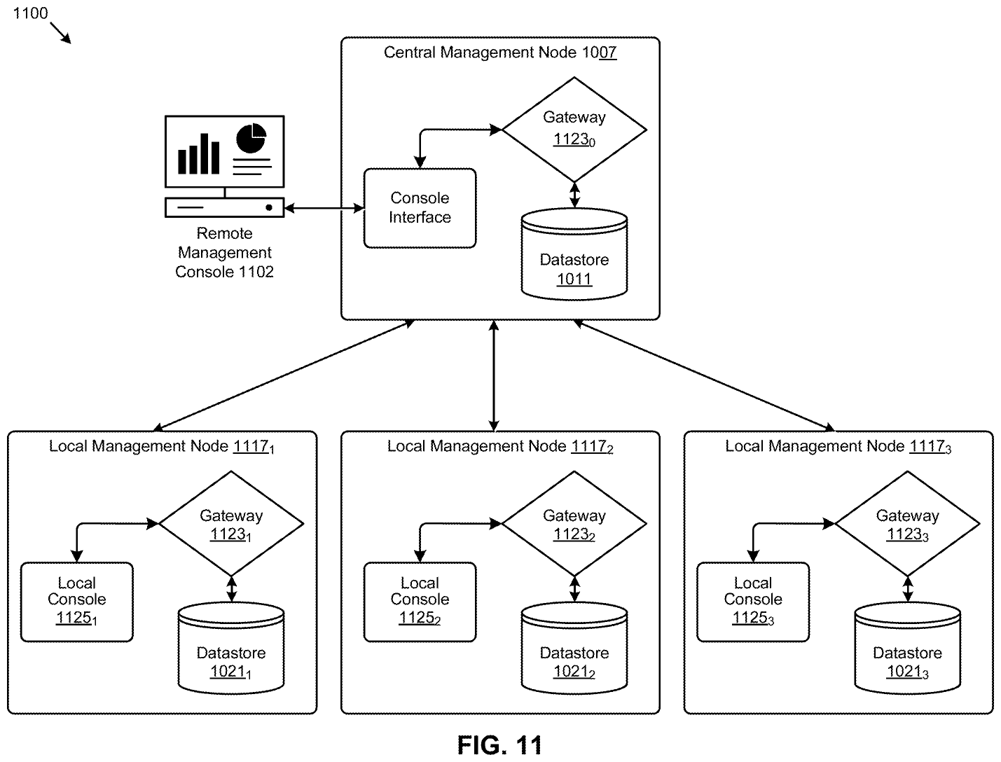

FIG. 11 depicts distributed workload partitioning 1100 in an environment comprising systems that perform seasonal time series analysis and forecasting using a distributed tournament selection process. As an option, one or more variations of distributed workload partitioning 1100 or any aspect thereof may be implemented in the context of the architecture and functionality of the embodiments described herein. The distributed workload partitioning 1100 or any aspect thereof may be implemented in any environment.

The embodiment shown in FIG. 11 is merely one example. FIG. 11 illustrates a larger computing environment having multiple underlying systems/clusters that are subject to active management. A separate management node exists for each of the underlying systems/clusters.

The architecture for implementing the seasonal time series analysis and forecasting using a distributed tournament selection process may be operated using a virtualization management console (e.g., the shown remote management console 1102), however the means of control and interfacing with the system may reside on a central management node 1007.

Shown here are local management nodes (e.g., local management node 1117₁, local management node 1117₂, and local management node 1117₃). Each of these local management nodes includes its own local management consoles (e.g., local console 1125₁, local console 1125₂, local console 1125₃), gateways (e.g., gateway 1123₀, gateway 1123₁, gateway 1123₂, gateway 1123₃), and datastores (e.g., datastore 1021₁, datastore 1021₂, datastore 1021₃). Further, information for and about one or more clusters may be used as inputs to the architecture for implementing the seasonal time series analysis and forecasting using a distributed tournament selection process such that one or more clusters can be used to perform predictions and runway calculations either for a cluster itself or another cluster, or all clusters may be analyzed as a whole or separately with the potential of sharing or migrating infrastructure from one node to another node. All clusters may be controlled as a whole or separately using interfacing capabilities provided by the remote management console.

### Additional Embodiments of the Disclosure

### Additional Practical Application Examples

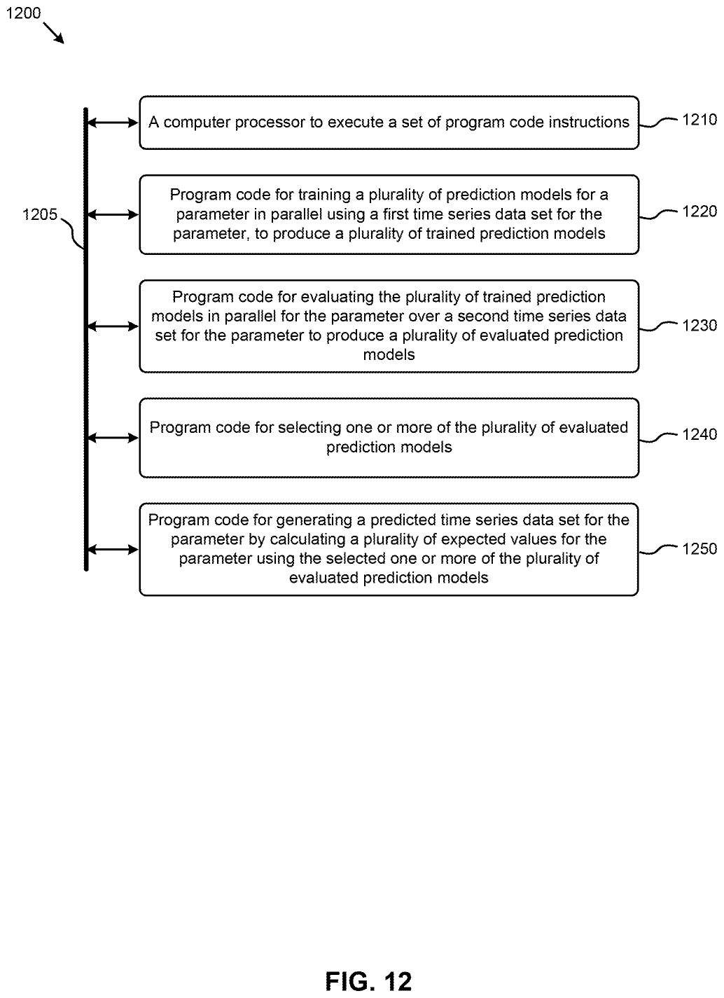

FIG. 12 depicts a system 1200 as an arrangement of computing modules that are interconnected so as to operate cooperatively to implement certain of the herein-disclosed embodiments. The partitioning of system 1200 is merely illustrative and other partitions are possible. As an option, the system 1200 may be implemented in the context of the architecture and functionality of the embodiments described herein. Of course, however, the system 1200 or any operation therein may be carried out in any desired environment.

The system 1200 comprises at least one processor and at least one memory, the memory serving to store program instructions corresponding to the operations of the system. As shown, an operation can be implemented in whole or in part using program instructions accessible by a module. The modules are connected to a communication path 1205, and any operation can communicate with other operations over communication path 1205. The modules of the system can, individually or in combination, perform method operations within system 1200. Any operations performed within system 1200 may be performed in any order unless as may be specified in the claims.

The shown embodiment implements a portion of a computer system, presented as system 1200, comprising a computer processor to execute a set of program code instructions (module 1210) and modules for accessing memory to hold program code instructions to perform: training a plurality of prediction models for a parameter in parallel using a first time series data set for the parameter, to produce a plurality of trained prediction models (module 1220); evaluating the plurality of trained prediction models in parallel for the parameter over a second time series data set for the parameter to produce a plurality of evaluated prediction models (module 1230); selecting one or more of the plurality of evaluated prediction models (module 1240); and generating a predicted time series data set for the parameter by calculating a plurality of expected values for the parameter using the selected one or more of the plurality of evaluated prediction models (module 1250).

Variations of the foregoing may include more or fewer of the shown modules and variations may perform more or fewer (or different) steps, and/or may use data elements in more, or fewer, or different operations.

Some embodiments include variations that comprise acts for receiving event information comprising at least a parameter for analysis and a time period.

Some embodiments include variations that comprise acts for generating one or more recommended changes to a system associated with the past time series data set to support an expected workload associated with the predicted time series data set.

Some embodiments include variations where the acts for generating one or more recommended changes further comprises receiving one or more determined solutions from a sizing unit using at least some of the predicted time series data set for the parameter.

Some embodiments include variations where the one or more determined solution from a sizing unit are determined using a plurality of sets of predicted time series data sets.

Some embodiments include variations where evaluating the plurality of trained prediction models further comprises a map reduce function.

Some embodiments include variations where the selected one or more of the plurality of evaluated prediction models are separate prediction models, aggregated prediction models, or a combination thereof.

Some embodiments include variations that comprise acts for indexing the first time series data set with the selected one or more of the plurality of prediction models.

Some embodiments include variations that comprise acts for selecting an evaluated prediction model by comparing indexed past time series data and different past time series data (e.g., using a map reduce function).

Some embodiments include variations where the plurality of prediction models comprises at least one of, an ARIMA model, or an ETS model, or an STL model, or a THETA model, or a TBATS model, or a neural network, or a random walk model, or a seasonal model, or a linear regression model, or a combination thereof.

### System Architecture Overview

### Additional System Architecture Examples

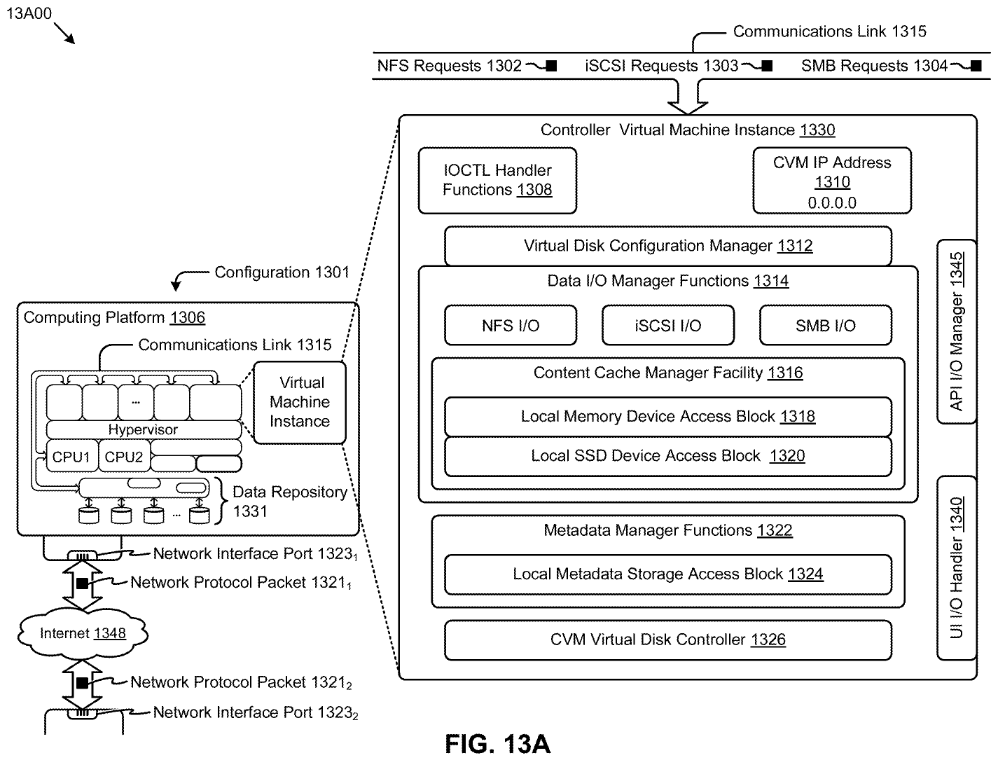

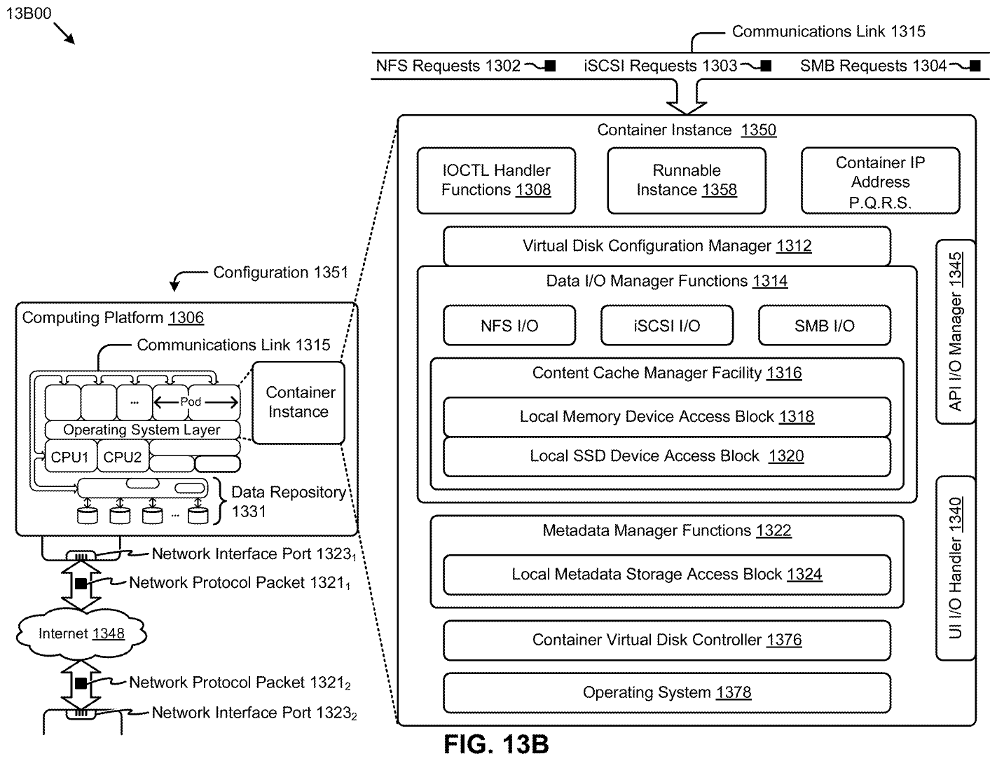

FIG. 13A depicts a virtualized controller architecture 13A00 comprising a collection of interconnected components suitable for implementing embodiments of the present disclosure and/or for use in the herein-described environments. The shown virtualized controller architecture 13A00 includes a virtual machine instance in a configuration 1301 that is further described as pertaining to the controller virtual machine instance 1330. A controller virtual machine instance receives block I/O (input/output or IO) storage requests as network file system (NFS) requests in the form of NFS requests 1302, and/or internet small computer storage interface (iSCSI) block IO requests in the form of iSCSI requests 1303, and/or Samba file system (SMB) requests in the form of SMB requests 1304. The controller virtual machine (CVM) instance publishes and responds to an internet protocol (IP) address (e.g., see CVM IP address 1310. Various forms of input and output (I/O or IO) can be handled by one or more IO control handler functions (see IOCTL functions 1308) that interface to other functions such as data IO manager functions 1314 and/or metadata manager functions 1322. As shown, the data IO manager functions can include communication with a virtual disk configuration manager 1312 and/or can include direct or indirect communication with any of various block IO functions (e.g., NFS IO, iSCSI IO, SMB IO, etc.).

In addition to block IO functions, the configuration 1301 supports IO of any form (e.g., block IO, streaming IO, packet-based IO, HTTP traffic, etc.) through either or both of a user interface (UI) handler such as UI IO handler 1340 and/or through any of a range of application programming interfaces (APIs), possibly through the shown API IO manager 1345.

The communications link 1315 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 1330 includes a content cache manager facility 1316 that accesses storage locations, possibly including local dynamic random access memory (DRAM) (e.g., through the local memory device access block 1318) and/or possibly including accesses to local solid state storage (e.g., through local SSD device access block 1320).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 1331, which in turn can be formatted into any one or more storage areas, and which can comprise parameterized storage accessible by a key (e.g., a filename, a table name, a block address, an offset address, etc.). An external data repository 1331 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 1324. The external data repository 1331 can be configured using a CVM virtual disk controller 1326, which can in turn manage any number or any configuration of virtual disks.

Execution of the sequences of instructions to practice certain embodiments of the disclosure are performed by a one or more instances of a processing element such as a data processor, or such as a central processing unit (e.g., CPU1, CPU2). According to certain embodiments of the disclosure, two or more instances of a configuration 1301 can be coupled by a communications link 1315 (e.g., backplane, LAN, PTSN, wired or wireless network, etc.) and each instance may perform respective portions of sequences of instructions as may be required to practice embodiments of the disclosure.

The shown computing platform 1306 is interconnected to the Internet 1348 through one or more network interface ports (e.g., network interface port 1323₁ and network interface port 1323₂). The configuration 1301 can be addressed through one or more network interface ports using an IP address. Any operational element within computing platform 1306 can perform sending and receiving operations using any of a range of network protocols, possibly including network protocols that send and receive packets (e.g., see network protocol packet 1321₁ and network protocol packet 1321₂).

The computing platform 1306 may transmit and receive messages that can be composed of configuration data, and/or any other forms of data and/or instructions organized into a data structure (e.g., communications packets). In some cases, the data structure includes program code instructions (e.g., application code) communicated through Internet 1348 and/or through any one or more instances of communications link 1315. Received program code may be processed and/or executed by a CPU as it is received and/or program code may be stored in any volatile or non-volatile storage for later execution. Program code can be transmitted via an upload (e.g., an upload from an access device over the Internet 1348 to computing platform 1306). Further, program code and/or results of executing program code can be delivered to a particular user via a download (e.g., a download from the computing platform 1306 over the Internet 1348 to an access device).

The configuration 1301 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor. Some embodiments include one or more special-purpose hardware components (e.g., power control, logic, sensors, transducers, etc.). A module may include one or more state machines and/or combinational logic used to implement or facilitate the operational and/or performance characteristics of the herein-described seasonal time series analysis and forecasting.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of seasonal time series analysis and forecasting using a distributed tournament selection process). Such files or records can be brought into and/or stored in volatile or non-volatile memory.

FIG. 13B depicts a containerized virtualized controller architecture 13B00 comprising a collection of interconnected components suitable for implementing embodiments of the present disclosure and/or for use in the herein-described environments. The shown containerized architecture includes a container instance in a configuration 1351 that is further described as pertaining to the container instance 1350. The configuration 1351 includes a daemon (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The daemon can perform port forwarding to any container (e.g., container instance 1350). A container instance can be executed by a processor. Runnable portions of a container instance sometimes derive from a container image, which in turn might include all, or portions of any of, a Java archive repository (JAR) and/or its contents, a script or scripts and/or a directory of scripts, a virtual machine configuration, and may include any dependencies therefrom. In some cases a virtual machine configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container (e.g., a Docker container) can be rooted in a directory system, and can be accessed by file system commands (e.g., “1s” or “1s-a”, etc.). The container might optionally include an operating system 1378, however such an operating system need not be provided. Instead, a container can include a runnable instance 1358, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 1376. Such a container virtual disk controller can perform any of the functions that the aforementioned CVM virtual disk controller 1326 can perform, yet such a container virtual disk controller does not rely on a hypervisor or any particular operating system so as to perform its range of functions.

In some environments multiple containers can be collocated and/or share one or more context. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

### Other Embodiments and Environments

In the foregoing specification, the disclosure has been described with reference to specific embodiments thereof. Illustrative examples have been described with respect to a clustered virtualization system. It is noted that the system is not limited to such systems, and one skilled in the art would readily understand from this disclosure that other types of distributed systems can be used to implement distributed processing according to some embodiments. Therefore, the disclosure is not to be limited to clustered virtualization systems unless explicitly claimed as such. Furthermore, the training process may include ranking or evaluation of each model and/or some combination of models by determining at least how well the models or combination of models match a second set of time series data.

It is evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
training multiple models for a parameter using a first data set to produce multiple trained models for a virtualization environment comprising a first computing node and a second computing node;
evaluating the multiple trained models for the parameter over a second data set for the parameter;
selecting a first model and a second model from the multiple trained models, wherein the first model provides predictions with different levels of accuracy for the first computing node and the second computing node;
generating a final model for the virtualization environment at least by aggregating the first model and the second model into the final model; and
generating predicted data for the parameter for both the first computing node and the second computing node in the virtualization at least by determining an expected value for the parameter using the final model that has been selected.

2. The method of claim 1, further comprising receiving event information pertaining to the parameter and a respective time period.

3. The method of claim 1, further comprising generating a recommended change.

4. The method of claim 3, wherein generating the recommended changing further comprises receiving a determined solution based at least in part on the predicted data for the parameter.

5. The method of claim 4, wherein the recommended change is determined using multiple sets of the predicted data.

6. The method of claim 1, wherein training the multiple trained models uses a map reduce function.

7. The method of claim 1, wherein evaluating the multiple trained models uses a map reduce function.

8. The method of claim 1, wherein the first model or the second model comprises at least one of a separate prediction model, an aggregated prediction model, or any combination thereof.

9. The method of claim 1, wherein the predicted data comprises data concerning at least one of storage pool TO usage or storage pool IO latency.

10. A non-transitory computer readable medium having stored thereon a sequence of instructions which, when stored in memory and executed by a processor, causes the processor to perform a set of acts, the set of acts comprising:
training multiple models for a parameter using a first data set to produce multiple trained models for a virtualization environment comprising a first computing node and a second computing node;
evaluating the multiple trained models for the parameter over a second data set for the parameter;
selecting a first model and a second model from the multiple trained models, wherein the first model provides predictions with different levels of accuracy for the first computing node and the second computing node;
generating a final model for the virtualization environment at least by aggregating the first model and the second model into the final model; and
generating predicted data for the parameter for both the first computing node and the second computing node in the virtualization at least determining an expected value for the parameter using the final model that has been selected.

11. The non-transitory computer readable medium of claim 10, further comprising instructions which, when stored in the memory and executed by the processor, causes the processor to perform acts of receiving event information pertaining to the parameter and a respective time period.

12. The non-transitory computer readable medium of claim 10, further comprising instructions which, when stored in the memory and executed by the processor causes the processor to perform acts of generating a recommended change.

13. The non-transitory computer readable medium of claim 12, wherein the sequence of instructions for generating the recommended change further comprises instructions which, when stored in the memory and executed by the processor, causes the processor to perform acts of receiving a determined solution based at least in part on the predicted data for the parameter.

14. The non-transitory computer readable medium of claim 13, wherein the recommended change is determined using multiple sets of the predicted data.

15. The non-transitory computer readable medium of claim 10, wherein training the multiple models uses a map reduce function.

16. The non-transitory computer readable medium of claim 10, wherein evaluating the multiple trained models uses a map reduce function.

17. The non-transitory computer readable medium of claim 10, wherein the first model or the second model comprises at least one of a separate prediction model, or an aggregated prediction model, or any combination thereof.

18. The non-transitory computer readable medium of claim 17, further comprising instructions which, when stored in the memory and executed by the processor, causes the processor to perform acts of selecting a trained model from the multiple trained models by comparing time series data using a map reduce function.

19. A system comprising:
a non-transitory storage medium having stored thereon a sequence of instructions; and
a processor that executes the sequence of instructions to cause the processor to perform a set of acts, the set of acts comprising,
training multiple models for a parameter using a first data set to produce multiple trained models for a virtualization environment comprising a first computing node and a second computing node;
evaluating the multiple trained models for the parameter over a second data set for the parameter;
selecting a first model and a second model from the multiple trained models, wherein the first model provides predictions with different levels of accuracy for the first computing node and the second computing node;
generating a final model for the virtualization environment at least by aggregating the first model and the second model into the final model; and
generating predicted data for the parameter for both the first computing node and the second computing node in the virtualization at least by determining an expected value for the parameter using the final model that has been selected.

20. The system of claim 19, the set of acts further comprising generating a recommended change.
